(19) United States
(12) Patent Application Publication
(10) Pub. No.: US 2025/0338258 A1
(43) Pub. Date: Oct. 30, 2025

(54) TRANSMISSION OR RECEPTION CONFIGURATION METHOD AND TERMINAL

(71) Applicant: VIVO MOBILE COMMUNICATION CO., LTD., Dongguan (CN)

(72) Inventors: Siqi LIU, Dongguan (CN); Zichao JI, Dongguan (CN); Shixiao LIU, Dongguan (CN)

(73) Assignee: VIVO MOBILE COMMUNICATION CO., LTD., Dongguan (CN)

(21) Appl. No.: 19/260,342

(22) Filed: Jul. 4, 2025

Related U.S. Application Data
(63) Continuation of application No. 17/947,078, filed on Sep. 16, 2022.
Application No. 17/947,078 is a continuation of application No. PCT/CN2021/080395, filed on Mar. 12, 2021.

(30) Foreign Application Priority Data
Mar. 19, 2020 (CN) 202010197625.7

(51) Int. Cl. H04W 72/02; H04W 24/08; H04W 72/0446; H04W 72/20

(52) U.S. Cl. CPC H04W 72/02; H04W 24/08; H04W 72/0446; H04W 72/20

(57) ABSTRACT

A transmission or reception configuration method and a terminal are provided. The transmission or reception configuration method is performed by a first terminal and includes: obtaining a transmission or reception configuration, where the transmission or reception configuration is used for configuration of a target parameter, where the target parameter includes a first preset timer, and the first preset timer includes a round-trip time timer (RTT timer); obtaining a first target moment; and starting the first preset timer at the first target moment, where the first target moment is a first preset moment or the first preset moment shifted by a first offset. The first preset moment includes a moment at which a physical uplink control channel (PUCCH) is sent or a moment associated with a last obtained sidelink downlink control information (SL DCI).

### CROSS-REFERENCE TO RELATED APPLICATIONS

This application is a continuation of U.S. application Ser. No. 17/947,078, filed Sep. 16, 2022, which is a continuation of International Application No. PCT/CN2021/080395, filed Mar. 12, 2021, which claims priority to Chinese Patent Application No. 202010197625.7, filed Mar. 19, 2020. The entire contents of each of the above-referenced applications are expressly incorporated herein by reference.

### TECHNICAL FIELD

The present disclosure relates to the field of communications technologies, and in particular, to a transmission or reception configuration method and a terminal.

### BACKGROUND

In Discontinuous Reception (DRX) of an interface (for example, a Uu interface) between a terminal and a network-side device, a user monitors only a Physical Downlink Control Channel (PDCCH) within an active time, to implement energy saving, where the active time includes on duration time, activity timer runtime, and retransmission timer runtime. Uu DRX does not impose a limitation on the time of uplink transmission and another downlink transmission of the user. For example, the user may send a Hybrid Automatic Repeat Request Acknowledgement (HARQ-ACK) to a base station outside the active time.

A sidelink (SL) Semi-Persistent Scheduling (SPS) period may include one or more SL resources, an SL Configured Grant (CG) period may include one or more SL resources, an SL downlink control information (DCI) (DCI for scheduling an SL transmission resource) may schedule one or more SL resources, and one piece of sidelink control information (SCI) may schedule one or more SL resources. These resources may be reserved for subsequent transmission or reception within a period of time. Each of the foregoing resources may include SCI, and only a part of resources scheduled in a same period or by one piece of DCI or indicated by one piece of SCI may be within an active time, and the other part of resources are outside the active time. (Physical Sidelink Feedback Channel (PSFCH) corresponding to resources scheduled in a same period or by one piece of DCI or indicated by one piece of SCI may be outside the active time.

If the design of Uu DRX is directly reused, the user no longer receives these pieces of SCI or PSFCHs, resulting in packet loss, low reliability, and low resource utilization.

### SUMMARY

Embodiments of the present disclosure provide a transmission or reception configuration method and a terminal.

According to a first aspect, an embodiment of the present disclosure provides a transmission or reception configuration method, performed by a first terminal and including:
obtaining a transmission or reception configuration, where the transmission or reception configuration is used to configure a target parameter; and
executing at least one of the following according to the transmission or reception configuration:
executing a sensing control behavior in a time domain range corresponding to the target parameter;
executing a measurement control behavior in the time domain range corresponding to the target parameter;
executing a resource selection or reselection control behavior in the time domain range corresponding to the target parameter; or
executing a transmission or reception control behavior of a target object in the time domain range corresponding to the target parameter, where
the target parameter includes a first preset time domain range or a first preset timer.

According to a second aspect, an embodiment of the present disclosure provides a transmission or reception configuration method, performed by a second terminal and including:
obtaining a transmission or reception configuration, where the transmission or reception configuration is used to configure a target parameter; and
executing at least one of the following according to the transmission or reception configuration:
executing a sending control behavior in a time domain range corresponding to the target parameter; or
executing a transmission or reception control behavior of a target object in the time domain range corresponding to the target parameter, where
the target parameter includes a second preset time domain range or a second preset timer.

According to a third aspect, an embodiment of the present disclosure further provides a terminal, where the terminal is a first terminal and includes:
a first obtaining module, configured to obtain a transmission or reception configuration, where the transmission or reception configuration is used to configure a target parameter; and
a first transmission or reception control module, configured to execute at least one of the following according to the transmission or reception configuration:
executing a sensing control behavior in a time domain range corresponding to the target parameter;
executing a measurement control behavior in the time domain range corresponding to the target parameter;
executing a resource selection or reselection control behavior in the time domain range corresponding to the target parameter; or
executing a transmission or reception control behavior of a target object in the time domain range corresponding to the target parameter, where
the target parameter includes a first preset time domain range or a first preset timer.

According to a fourth aspect, an embodiment of the present disclosure further provides a terminal, where the terminal is a second terminal and includes:
a second obtaining module, configured to obtain a transmission or reception configuration, where the transmission or reception configuration is used to configure a target parameter; and
a second transmission or reception control module, configured to execute at least one of the following according to the transmission or reception configuration:
executing a sending control behavior in a time domain range corresponding to the target parameter; or
executing a transmission or reception control behavior of a target object in the time domain range corresponding to the target parameter, where
the target parameter includes a second preset time domain range or a second preset timer.

According to a fifth aspect, an embodiment of the present disclosure further provides a terminal, including: a processor, a memory, and a computer program that is stored in the memory and that can be run on the processor, where when the computer program is executed by the processor, the steps of the foregoing transmission or reception configuration method are implemented.

According to a sixth aspect, an embodiment of the present disclosure further provide a computer-readable storage medium, where the computer-readable storage medium stores a computer program, and when the computer program is executed by a processor, the steps of the foregoing transmission or reception configuration method are implemented.

According to a seventh aspect, an embodiment of the present disclosure further provides a computer software product, where the computer software product is stored in a non-volatile storage medium, and the software product is configured to be executed by at least one processor to implement the steps of the foregoing transmission or reception configuration method.

According to an eighth aspect, an embodiment of the present disclosure further provides a terminal, where the terminal is configured to execute the foregoing transmission or reception configuration method.

The beneficial effects of the present disclosure are as follows:

In the foregoing solution, behaviors that meet requirements are executed in a time domain range corresponding to a target parameter according to a transmission or reception configuration, thereby limiting a transmission or reception behavior of a terminal, avoiding packet removal, and improving communication reliability and resource utilization.

### BRIEF DESCRIPTION OF DRAWINGS

FIG. 1 is a schematic diagram of a DRX format;

FIG. 2 is a schematic diagram of scheduling three PSCCH/PSSCH transmission or reception resources by one piece of SL DCI;

FIG. 3 is a schematic diagram of scheduling and periodically reserving three PSCCH/PSSCH transmission or reception resources by one piece of SCI;

FIG. 4 is a schematic diagram of a relationship among a PSSCH, a sub-channel, and a PSFCH RB;

FIG. 5 is a schematic diagram of a relationship between a physical slot and a logical slot;

FIG. 6 is a first schematic flowchart of a transmission or reception configuration method according to an embodiment of the present disclosure;

FIG. 7 is a first schematic module diagram of a terminal according to an embodiment of the present disclosure;

FIG. 8 is a structural block diagram of a terminal according to an embodiment of the present disclosure;

FIG. 9 is a second schematic flowchart of a transmission or reception configuration method according to an embodiment of the present disclosure; and

FIG. 10 is a second schematic module diagram of a terminal according to an embodiment of the present disclosure.

### DETAILED DESCRIPTION

To make the objectives, technical solutions, and advantages of the present disclosure clearer, the following describes the present disclosure in detail with reference to the accompanying drawings and specific embodiments.

In the descriptions of the embodiments of the present disclosure, some concepts used in the following descriptions are first explained and described.

### 1. Description of Discontinuous Reception (DRX) on an Interface (That is, a Uu Interface) Between a Long Term Evolution (LTE) and New Radio (NR) Terminal and a Network Side Device

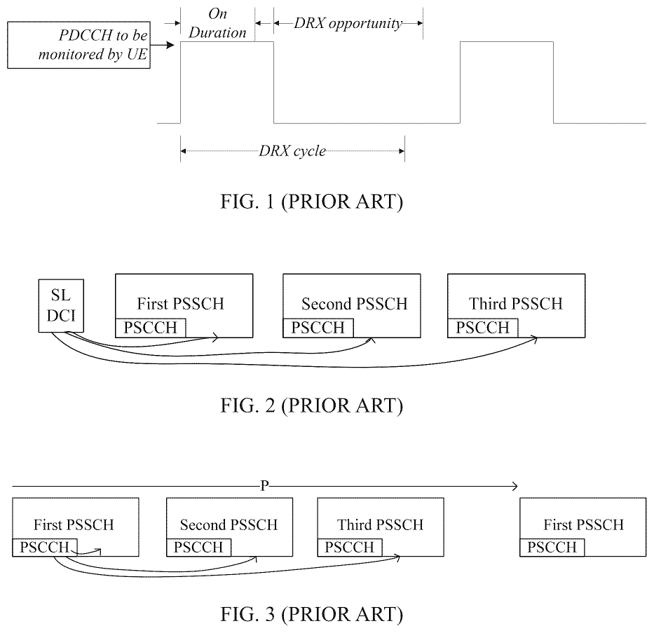

A DRX mechanism is introduced in both LTE and NR, and power saving of User Equipment (UE, also referred to as a terminal) is achieved by configuring a DRX on time and a DRX off time. As shown in FIG. 1, on duration is an interval of DRX on, and the UE enters off duration of a DRX cycle if scheduling is not executed after on duration.

### 2. Description of a Sidelink (SL)

The sidelink design supports two resource allocation modes: a scheduled resource allocation mode (commonly referred to as a mode-1) and an autonomous resource selection mode (commonly referred to as a mode-2). In the former mode, a network side device controls and allocates a resource to each UE, and in the latter mode, the UE independently selects a resource. In the mode-1, Radio Resource Control (RRC) or one piece of downlink control information (DCI) may indicate one or more resources, for example, as shown in FIG. 2, a resource SL configured grant (SL CG) that appears in a configuration period. In mode-2, a user may obtain a resource through sensing (detection), and one piece of SCI may indicate one or more resources. Further, the one or more resources may be further periodically reserved, for example, as shown in FIG. 3. In some embodiments, a terminal determines, through SCI sensing and/or measuring, which resources have been occupied by another terminal, to select, from remaining resources, a resource used for transmission or reception by the terminal.

A PSCCH in an LTE sidelink carries SCI, and a PSCCH and a PSSCH in an NR sidelink separately carry a part of the SCI. The SCI is used to schedule a PSSCH. The SCI may indicate transmission or reception resources, and may further reserve these resources for subsequent transmission or reception. A Physical Sidelink Feedback Channel (PSFCH) is used to feed back sidelink HARQ-ACK information. After determining sidelink HARQ-ACK information, the user may further send the sidelink HARQ-ACK information to a base station by using a PUCCH or a PUSCH.

### PSFCH Resource

A PSSCH occupies N sub-channels in frequency domain, and a PSFCH resource occupies only one Resource Block (RB) in frequency domain. Therefore, a quantity of PSFCH RBs in a same resource pool is far greater than a quantity of PSSCH occasions.

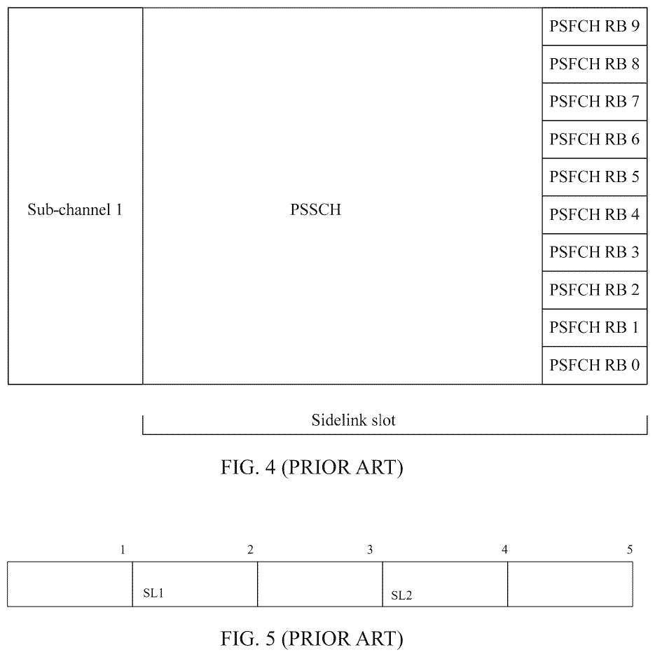

As shown in FIG. 4, a PSSCH resource occupies one sub-channel in frequency domain, and 10 PSFCH RBs exist in the sub-channel.

A PSFCH occasion appears once every N slots (sidelink slot), that is, a PSFCH period N=1, 2, 4. Therefore, some SL slots have a PSCCH/PSSCH and a PSFCH, and some SL slots have only a PSCCH/PSSCH without a PSFCH. In each period, N PSSCH occasions may be associated with the PSFCH occasion, and a time of a PSSCH occasion associated with the PSSCH occasion on a slot m is not earlier than m+K, where K=2, 3.

It should be noted that Subcarrier Spacing (SCS) of the foregoing parameters may be the same or different. K and N are logical slots (SL slot). Therefore, an actual distance between K SL slots may be greater than duration corresponding to K physical slots, and an actual distance between N SL slots may be greater than duration corresponding to N physical slots. As shown in FIG. 5, it is assumed that physical slots 2 and 4 in five physical slots are used for SL. Therefore, logical slot numbers or SL slot numbers of the two SL slots are 1 and 2. In this case, an actual distance between logical slots 1 and 2 is 2 physical slots and is greater than duration corresponding to one slot.

### Cast Type and HARQ Feedback Mode

The NR sidelink supports three transmission or reception modes: broadcast, multicast and unicast. The multicast in the NR sidelink supports two types: connection-based multicast and connection-less multicast. The connection-based multicast is a scenario in which a connection is established between multicast UE, and the connection-less mode is a scenario in which multicast UE does not know other UE in the group, and no connection is established. In the case of multicast, a plurality of receive ends support two mechanisms when performing a HARQ feedback:

Multicast mechanism 1 (option 1 NACK-only feedback or connection-less mechanism): If the data is received but cannot be parsed, a NACK is fed back; otherwise, no feedback is executed.

Multicast mechanism 2 (option 2 ACK/NACK feedback, or connection-based mechanism): If the data is received but cannot be parsed or SCI is received but no data is received, a Negative Acknowledgement (NACK) is fed back; if the data is received and is correctly parsed, an Acknowledgement (ACK) is fed back.

The present disclosure provides a transmission or reception configuration method and a terminal.

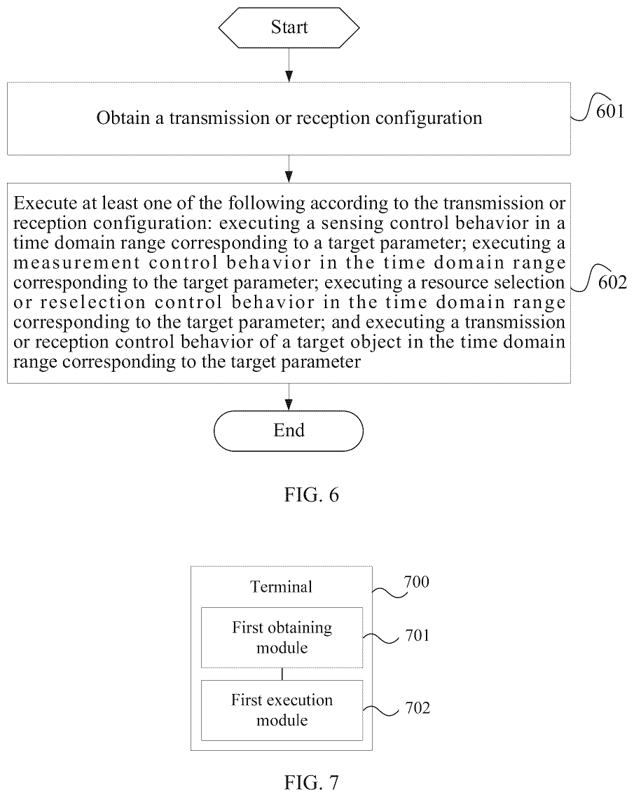

As shown in FIG. 6, an embodiment of the present disclosure provides a transmission or reception configuration method, performed by a first terminal and including:

Step 601: Obtain a transmission or reception configuration.

It should be noted that the transmission or reception configuration is used to configure a target parameter. In some embodiments, the target parameter includes a first preset time domain range or a first preset timer.

Step 602: Execute at least one of the following according to the transmission or reception configuration:
A11. executing a sensing control in a time domain range corresponding to the target parameter;
A12. executing a measurement control behavior in the time domain range corresponding to the target parameter;
A13. executing a resource selection or reselection control behavior in the time domain range corresponding to the target parameter; or
A14. executing a transmission or reception control behavior of a target object in the time domain range corresponding to the target parameter.

It should be noted that the time domain range mentioned in this embodiment of the present disclosure may be interpreted as a time window or a time domain resource set. The time domain resource set includes at least one time domain resource. If the set includes a plurality of time domain resources, these resources may be consecutive or discrete in time domain. For example, the time domain range includes at least one sidelink slot.

Specific implementations of A11 to A14 are described in detail below from perspectives of different target parameters.

### 1. A11

When the target parameter is the first preset time domain range, the first preset time domain range includes a first time domain range and/or a second time domain range. In some embodiments, an implementation of A11 includes at least one of the following:
A111. Execute no sensing in the first time domain range.

It should be noted that, in this case, the first terminal does not detect a resource in the first time domain range.
A112. Execute sensing in the second time domain range.

It should be noted that, in this case, the first terminal may detect a resource in the second time domain range, but it is not specified that the first terminal certainly detects a resource in the second time domain range in this case.

When the target parameter is the first preset timer, the first preset timer includes a first timer and/or a second timer. It should be noted that the first timer may be at least one of a round-trip time timer (Round Trip Time timer, RTT timer), a waiting timer, an off timer, a sleep timer, or the like, and the second timer may be at least one of a retransmission timer (ReTX timer), an inactivity timer, an on duration timer, a measurement timer, a report timer, a response timer, or the like.

In some embodiments, an implementation of A11 includes at least one of the following:
A113. Execute no sensing during running of the first timer.

For example, the first terminal does not execute sensing during running of the first timer.

Further, for example, the first terminal does not execute sensing during running of a round-trip time timer.
A114. Execute sensing during running of the second timer.

For example, the first terminal executes sensing during running of the second timer.

Further, for example, the first terminal executes sensing during running of a retransmission timer.

### 2. A12

It should be noted that measurement control herein mainly is measuring at least one of reference signal received power (RSRP) or a received signal strength indicator (RSSI).

When the target parameter is the first preset time domain range, the first preset time domain range includes a first time domain range and/or a second time domain range. In some embodiments, an implementation of A12 includes at least one of the following:
A121. Execute no measurement in the first time domain range.

It should be noted that in this case, the first terminal does not measure a signal in the first time domain range. For example, the first terminal does not measure an RS in the first time domain range.
A122. Execute measurement in the second time domain range.

It should be noted that in this case, the first terminal may measure a signal in the second time domain range. For example, the first terminal measures an RS in the second time domain range.

When the target parameter is the first preset timer, the first preset timer includes a first timer and/or a second timer. It should be noted that the first timer may be at least one of a round-trip time timer (RTT timer), a waiting timer, an off timer, a sleep timer, or the like, and the second timer may be at least one of a retransmission timer (ReTX timer), an inactivity timer, an on duration timer, a measurement timer, a report timer, a response timer, or the like.

In some embodiments, an implementation of A12 includes at least one of the following:
A123. Execute no measurement during the running of the first timer.

For example, the first terminal does not measure an RS during running of the first timer.

Further, for example, the first terminal does not measure an RS during running of a round-trip time timer.
A124. Execute measurement during running of the second timer.

For example, the first terminal measures an RS during running of the second timer.

Further, for example, the first terminal measures an RS during running of a retransmission timer.

### 3. A13

In some embodiments, in this case, when the target parameter is the first preset time domain range, the first preset time domain range includes a first time domain range and/or a second time domain range. In some embodiments, an implementation of A13 includes at least one of the following:
A131. Execute no resource selection or reselection in the first time domain range.

It should be noted that in this case, the first terminal may not execute resource selection or reselection in the first time domain range, but it is not specified that the first terminal certainly executes no resource selection or reselection in the first time domain range.
A132. Execute resource selection or reselection in the second time domain range.

It should be noted that in this case, the first terminal may execute resource selection or reselection in the second time domain range, but it is not specified that the first terminal certainly executes resource selection or reselection in the second time domain range.
A133. The first terminal does not select or reselect a resource in the first time domain range.
A134. The first terminal selects or reselects a resource in the second time domain range.

When the target parameter is the first preset timer, the first preset timer includes a first timer and/or a second timer. It should be noted that the first timer may be at least one of a round-trip time timer (RTT timer), a waiting timer, an off timer, a sleep timer, or the like, and the second timer may be at least one of a retransmission timer (ReTX timer), an inactivity timer, an on duration timer, a measurement timer, a report timer, a response timer, or the like.

In some embodiments, implementation of A13 includes at least one of the following:
A135. Execute no resource selection or reselection during running of the first timer.

For example, the first terminal does not execute resource selection during running of the first timer.

Further, for example, the first terminal does not execute resource selection during running of a round-trip time timer.
A136. Execute resource selection or reselection during running of the second timer.

For example, the first terminal executes resource reselection during running of the second timer.

Further, for example, the first terminal executes resource reselection during running of a retransmission timer.
A137. The first terminal does not select or reselect a resource during running of the first timer.

For example, the first terminal does not select a resource during running of the first timer.

Further, for example, the first terminal does not select a resource during running of a round-trip time timer.
A138. The first terminal selects or reselects a resource during running of the second timer.

For example, the first terminal selects a resource during running of the second timer.

Further, for example, the first terminal selects a resource during running of a retransmission timer.

### 1. A14

First, it should be noted that the target object includes at least one of a first request, sidelink control information (SCI), a Physical Sidelink Control Channel (PSCCH), a Physical Sidelink Shared Channel (PSSCH), a Reference Signal (RS), and a measurement report, for example, monitoring an RS, or monitoring SCI.

In some embodiments, the first request may include at least one of a synchronization request, a reference signal request, a measurement report request (for example, at least one of a CSI report request, an RSRP report request, an RSRQ report request, and an RSSI report request), a connection establishment request, a connection resume request, a link resume request, a link re-establishment request, a reconfiguration request, a retransmission request, or the like.

The reference signal may include a Channel State Information-Reference Signal (CSI-RS), a phase-tracking reference signal (PT-RS), an uplink Sounding Reference Signal (SRS), a Positioning Reference Signal (PRS), and the like.

The measurement report may be, for example, a channel state information report (CSI report), a reference signal received power report (RSRP report), a reference signal received quality report (RSRQ report), or a received signal strength indicator report (RSSI report).

In some embodiments, in this case, when the target parameter is the first preset time domain range, the first preset time domain range includes a first time domain range and/or a second time domain range. An implementation of A14 includes at least one of the following:
A141. The first terminal does not monitor or receive the target object in the first time domain range.

For example, the first terminal does not monitor (or does not receive) SCI in the first time domain range.
A142. The first terminal monitors (detect or monitor) or receives the target object in the second time domain range.

For example, the first terminal monitors (or receives) SCI in the second time domain range.

When the target parameter is the first preset timer, the first preset timer includes a first timer and/or a second timer. It should be noted that the first timer may be at least one of a round-trip time timer (RTT timer), a waiting timer, an off timer, a sleep timer, or the like, and the second timer may be at least one of a retransmission timer (ReTX timer), an inactivity timer, an on duration timer, a measurement timer, a report timer, a response timer, or the like.

Further, an implementation of A14 includes at least one of the following:
A143. The first terminal does not monitor or receive the target object during running of the first timer.

For example, the first terminal does not monitor (or does not receive) SCI during running of a round-trip time timer.
A144. The first terminal monitors or receives the target object during running of the second timer.

For example, the first terminal monitors (or receives) SCI during running of a retransmission timer.

It should be noted that, for the implementation of step 602, time domain ranges or timers of different lengths may be designed for different implementations, or time domain ranges or timers of a same length may be designed for different implementations.

Further, it should be noted that the transmission or reception configuration in this embodiment of the present disclosure may restrict receiving and/or sending. When the transmission or reception configuration restricts at least receiving of a terminal, the transmission or reception configuration may be considered as a sidelink discontinuous reception (DRX) configuration.

In some embodiments, the transmission or reception configuration is obtained in at least one of the following manners:
A21. being configured by a network side device;
A22. being preconfigured;
A23. being stipulated in a protocol;
A24. being indicated by another terminal; or
A25. being determined by the first terminal.

For example, the first terminal deduces a time domain range or duration of a timer by using a resource pool configuration and indication information in sidelink downlink control information (SL DCI, DCI for scheduling, activating, or deactivating an SL transmission or reception resource).

Further, it should be noted that, when the target parameter is the first preset time domain range or the first preset timer, and the time domain range includes a first sub-time domain range and/or a second sub-time domain range, a length of at least one of the first sub-time domain range and the second sub-time domain range is greater than or equal to at least one of the following parameters:
A31. Packet delay budget (PDB).
A32. 32 slots.

In some embodiments, the 32 slots herein may be 32 sidelink slots or 32 physical slots.
A33. M×P (that is, M times P).

It should be noted that P is a reservation period, a service period, a period indicated by SCI, a period of a sidelink configured grant (SL CG), or a period of sidelink semi-persistent scheduling (SL SPS), M is a positive integer, and M is configured or preconfigured by a network side device, stipulated in a protocol, or indicated by another terminal.
A34. J slots or milliseconds.

It should be noted that J is greater than or equal to 32+N and is less than or equal to 32+N+K−1 (that is, J belongs to an interval [32+N, 32+N+K−1]), or J is greater than or equal to RA_duration+N and is less than or equal to RA_duration+N+K−1 (that is, J belongs to an interval [RA_duration+N, RA_duration+N+K−1]).

It should be noted that some of the foregoing interval representations are a logical time, and some are a physical time. For example, N and K are the number of sidelink slots, and RA_duration may be the number of sidelink slots, or may be the number of physical slots. If units are different, the parameters need to be converted into results corresponding to a same unit.

It should be noted that subcarrier spacings (SCS) of the foregoing parameters may be different, for example, some are an UL SCS, and some are an SL SCS. If SCSs are different, the parameters need to be converted into results corresponding to a same SCS.

In some embodiments, N is a period of a feedback resource, K is a minimum time interval between a transmission or reception resource and a corresponding feedback resource, and RA_duration is a time domain range or a time domain distance occupied by two transmission or reception resources in preset transmission or reception resource. In some embodiments, RA_duration is a time domain range or a time domain distance occupied by the first transmission or reception resource and the last transmission or reception resource in the preset transmission or reception resources. In some embodiments, the time domain range is a physical time domain range or a logical time domain range. The time domain distance is a physical time domain distance or a logical time domain distance.

For example, if physical slots 2 and 4 in physical slots 1, 2, 3, 4, and 5 are used for a sidelink, the physical slots 2 and 4 correspond to sidelink slots 1 and 2. Therefore, a logical time domain distance between sidelink slots is one sidelink slot, and a physical time domain distance is two slots.

It should be noted herein that when the number of preset transmission or reception resources is 1, RA_duration=0 or 1.

In some embodiments, it should be further noted that the preset transmission or reception resource is a transmission or reception resource included in SL SPS, a transmission or reception resource included in an SL CG, a transmission or reception resource scheduled by sidelink downlink control information (SL DCI, DCI for scheduling an SL transmission or reception resource), or a transmission or reception resource indicated by SCI.

For the forgoing case, when the target parameter is the first preset timer, and the first preset timer includes a first timer and/or a second timer, the first sub-time domain range corresponds to timing duration of the first timer, and the second sub-time domain range corresponds to timing duration of the second timer; and
when the target parameter is the first preset time domain range and the first preset time domain range includes a first time domain range and/or a second time domain range, the first sub-time domain range corresponds to the first time domain range, and the second sub-time domain range corresponds to the second time domain range.

Further, it should be further noted that, regardless of whether the target parameter is the first preset time domain range or the target parameter is the first preset timer, the transmission or reception configuration method in this embodiment of the present disclosure further includes:
obtaining a first target moment, where the first target moment is a first preset moment, or the first target moment is a moment when the first preset moment is shifted by a first offset (that is, first target moment=first preset moment+first offset); and
the first target moment is a start point of the time domain range.

In some embodiments, the first offset is obtained in any one of A21 to A25.

Further, it should be noted that when the target parameter is the first preset timer, after the obtaining a first target moment, the method further includes:
starting the first preset timer at the first target moment.

Further, it should be noted herein that a condition for starting the first preset timer may be: starting the first preset timer starting from the first target moment, or starting the first preset timer after the first target moment.

Further, when the first preset timer includes a first timer or a second timer, a first target moment of the first timer is different from a first target moment of the second timer. Because a first target moment is mainly determined by a first preset moment, that is, when both the first timer and the second timer are included in this embodiment of the present disclosure, start moments of the first timer and the second timer are different, that is, manners of determining first preset moments for determining the start moments of the first timer and the second timer are different.

Further, it should be noted that when the target parameter is the first preset time domain range and the first preset time domain range includes a first time domain range or a second time domain range, a first target moment of the first time domain range is different from a first target moment of the second time domain range. Because a first target moment is mainly determined by a first preset moment, that is, when both the first time domain range and the second time domain range are included in this embodiment of the present disclosure, start moments of the first time domain range and the second time domain range are different, that is, manners of determining first preset moments for determining the start moments of the first time domain range and the second time domain range are different.

In some embodiments, in a first case, the first preset moment includes at least one of the following:
A401. Moment at which a resource is preempted.

It should be noted that, the preempted resource herein is a resource indicated or reserved by another terminal, or the preempted resource is an expected transmission or reception resource that is preempted.
A402. Moment at which the last transmission or reception resource is located.

For example, one piece of SCI indicates (reserves) three transmission or reception resources, and a moment at which the third transmission or reception resource is located is the first preset moment. For example, the first preset timer is started at the moment at which the third transmission or reception resource is located.
A403. Moment related to receiving the last transmission or reception resource.

In some embodiments, the last transmission or reception resource may be a PSSCH resource and/or a PSCCH resource. In some embodiments, the first preset moment is a time point determined based on the case that the last transmission or reception resource is received. For example, the first preset moment is a moment when the last transmission or reception resource is received or after the last transmission or reception resource is received.
A404. Moment at which a feedback resource corresponding to the first transmission or reception resource is located.

In some embodiments, the feedback resource is a PSFCH. That is, in this case, the first preset moment is a moment at which a PSFCH corresponding to the first transmission or reception resource is located.
A405. Moment at which a feedback resource corresponding to the last transmission or reception resource is located.

In some embodiments, the feedback resource is a PSFCH. That is, in this case, the first preset moment is a moment at which a PSFCH corresponding to the last transmission or reception resource is located.

For example, one piece of SCI indicates (reserves) three transmission or reception resources, and a moment at which a PSFCH corresponding to the third transmission or reception resource is located is the first preset moment. For example, the first preset timer is started at the moment at which the PSFCH corresponding to the third transmission or reception resource is located.

It should be noted herein that for A402 and A405, after the first terminal (which may also be considered as PSSCH/PSCCH RX UE) receives three transmission or receptions or feeds back the last PSFCH for three transmission or receptions, it may be assumed that a second terminal (which may be considered as PSSCH/PSCCH TX UE) no longer schedules retransmission in a period of time, and the PSSCH/PSCCH RX UE starts a round-trip time timer; or it is assumed that PSSCH/PSCCH TX UE schedules retransmission again in a period of time, and the PSSCH/PSCCH RX UE starts a retransmission timer.
A406. Moment at which a feedback resource is sent.

In some embodiments, the moment at which the feedback resource is sent includes: a moment at which the A^{th} feedback resource is sent or a moment at which the feedback resource corresponding to the last transmission or reception resource is sent, where
A is a positive integer, and A represents any feedback resource.

In some embodiments, the feedback resource is a PSFCH. For example, in this case, the sending a PSFCH may be sending the first PSFCH for a Transport Block (TB), or may be sending a PSFCH for a TB, or may be sending a PSFCH corresponding to the last transmission or reception resource (for example, a PSSCH resource and/or a PSCCH resource) for a TB.

It should be noted that a difference between the feedback resource corresponding to the last transmission or reception resource A405 and the sending the feedback resource in A406 is whether the sending succeeds. The sending the feedback resource limits the first PSFCH, but the feedback resource may be dropped and not be sent due to a priority problem.
A407. Moment at which a first response is sent.

In some embodiments, the first response may include a response to at least one of a synchronization request, a connection establishment request, a connection resume request, a link resume request, a link re-establishment request, a reconfiguration request, a retransmission request, or the like, for example, at least one of allowing or succeeding in synchronization, allowing or succeeding in establishing a connection, allowing or succeeding in resuming a connection, allowing or succeeding in resuming a link, allowing or succeeding in re-establishing a link, reconfiguring, or retransmitting, where the allowing or succeeding in synchronization may include at least one of allowing or succeeding being as synchronization reference, allowing or succeeding in transmitting a synchronization signal, or the like.
A408. Moment at which a Physical Uplink Control Channel (PUCCH) or a Physical Uplink Shared Channel (PUSCH) is sent.
A409. Moment related to sending a negative acknowledgment.

In some embodiments, the first preset moment is a time point determined based on the case that the negative acknowledgment is sent. For example, the first preset moment is a moment when the negative acknowledgment is sent, or the first preset moment is a moment after the negative acknowledgment is sent.

It should be noted that, this herein is a case that a NACK is received.

It should be noted that, for at least one of unicast, a multicast mechanism 1 (multicast option 1), or a multicast mechanism 2 (multicast option 2), this manner may be used for the first preset moment.

For example, a terminal (PSSCH/PSCCH RX UE) receiving a PSSCH and/or a PSCCH receives a TB transmitted through the multicast option 1, and a NACK is fed back.

It should be noted herein that, because PSSCH/PSCCHRX UE sends a NACK, after a terminal (PSSCH/PSCCH TX UE) sending a PSSCH and/or a PSCCH receives a PSFCH, it is considered that transmission or reception of the TB fails. It may be assumed that the PSSCH/PSCCH TX UE no longer schedules retransmission in a period of time, and the PSSCH/PSCCH RX UE starts a round-trip time timer after sending the NACK; or it is assumed that the PSSCH/PSCCH TX UE schedules retransmission again in a period of time, and the PSSCH/PSCCH RX UE starts a round-trip time timer after sending the NACK.

For example, if an SL CG or SPS period is P, the PSCCH/PSSCH RX UE may sleep after feeding back the NACK, that is, does not monitor a target object, until a resource corresponding to a next period. For example, if a resource at a moment corresponding to a moment at which a resource is located+M×P is reserved, the PSCCH/PSSCH RXUE may sleep after feeding back the NACK, that is, does not monitor a target object until a resource of a target object corresponding to M×P.

Further, it should be noted that this case includes at least one of the following:
A4091. Moment related to sending the first negative acknowledgment.

In some embodiments, the first preset moment is a time point determined based on the case that the first negative acknowledgment is sent. For example, in this case, the first preset moment is a moment at which the first NACK is sent for a TB.
A4092. Moment related to sending each negative acknowledgment

In some embodiments, the first preset moment is a time point determined based on the case that each negative acknowledgment is sent. For example, in this case, the first preset moment is a moment at which each NACK is sent for a TB.
A4093. Moment related to a case that the last feedback resource is sent and feedback content is a negative acknowledgment.

In some embodiments, the first preset moment is a time point determined based on the case that the last feedback resource is sent and the feedback content is a negative acknowledgment. For example, in this case, the first preset moment is a moment at which the last PSFCH is sent and feedback content in the PSFCH is a NACK.
A410. Moment related to sending no first response.

In some embodiments, the first preset moment is a time point determined based on the case that no first response is sent. For example, the first preset moment is a moment at which no first response is sent, or the first preset moment is a moment after no first response is sent.

It should be noted that, that no first response is sent may mean that transmission or reception of the first response is canceled due to a priority, and therefore, no first response is sent; or the first terminal does not obtain a corresponding transmission or reception resource, and therefore does not send the first response.

It should be noted that this case includes at least one of the following:
A4101. Moment related to sending no first response for the first time.

In some embodiments, the first preset moment is a time point determined based on the case that no first response is sent for the first time. For example, in this case, the first preset moment is a moment at which no first response is sent for a TB for the first time.
A4102. Moment related to sending no first response each time.

In some embodiments, the first preset moment is a time point determined based on the case that no first response is sent each time. For example, in this case, the first preset moment is a moment at which no first response is sent for a TB each time.
A4103. Moment related to not sending the last first response if all first responses are not sent.

In some embodiments, the first preset moment is a time point determined based on the case that the last first response is not sent if all first responses are not sent. For example, in this case, the first preset moment starts from a moment at which the last first response is not sent if all first responses are not sent for a TB.
A411. Moment related to sending no feedback resource.

In some embodiments, the first preset moment is a time point determined based on the case that no feedback resource is sent.

That no feedback resource is sent may mean that transmission or reception of a PSFCH resource is canceled due to a priority, and therefore no feedback resource is sent; or the first terminal does not receive a corresponding transmission or reception, and therefore does not send a feedback resource. In some embodiments, the feedback resource is a PSFCH.

It should be noted that, for at least one of unicast and a multicast mechanism 2 (multicast option 2), this manner may be used for the first preset moment. In this case, this is equivalent to sending of the first NACK.

For example, when a user of PSSCH/PSCCH RX UE receives a TB transmitted through the multicast option 2, the user does not send a PSFCH corresponding to the TB due to a reason of a limited transmit capability, limited power, or a priority.

It should be noted herein that, because the PSSCH/PSCCH RX UE does not send the PSFCH, and PSSCH/PSCCH TX UE cannot detect the PSFCH, it is considered that transmission or reception of the TB fails or a NACK is fed back. It may be assumed that the PSSCH/PSCCH TX UE no longer schedules retransmission in a period of time, and the PSSCH/PSCCH RX UE starts a round-trip time timer when the PSFCH is not sent; or it is assumed that the PSSCH/PSCCH TX UE may schedule retransmission as soon as possible in a period of time, and the PSSCH/PSCCH RX UE starts a retransmission timer when the PSFCH is not sent.

It should be noted that this case includes at least one of the following:
A4111. Moment related to sending no feedback resource for the first time.

In some embodiments, the first preset moment is a time point determined based on the case that no feedback resource is sent for the first time. For example, in this case, a PSFCH for a TB is not sent for the first time.
A4112. Moment related to sending no feedback resource each time.

In some embodiments, the first preset moment is a time point determined based on the case that no feedback resource is sent each time. For example, in this case, a PSFCH for a TB is not sent each time.
4113. Moment related to not sending the last feedback resource if all feedback resources are not sent.

In some embodiments, the first preset moment is a time point determined based on the case that the last feedback resource is not sent if all feedback resources are not sent.

For example, in this case, the first preset moment starts from a moment at which the last PSFCH is not sent if all PSFCHs are not sent for a TB.
A412. Moment at which a transmission or reception resource on which no target object is monitored or received is located when no target object is monitored or received on a reserved or indicated resource.

In this case, the first preset moment is the moment at which the last transmission or reception resource on which no target object is monitored or received is located when no target object is monitored or received on the reserved or indicated resource.

For example, the first preset moment is a moment at which the third transmission or reception resource on which no target object is monitored (or received) if the first terminal fails to monitor (or receive) a target object on three resources indicated by a PSCCH/PSSCH.
A413. Moment at which a feedback resource corresponding to the transmission or reception resource on which no target object is monitored or received is located when no target object is monitored or received on the reserved or indicated resource.

In this case, the first preset moment is the moment at which the feedback resource corresponding to the last transmission or reception resource on which no target object is monitored or received is located when no target object is monitored or received on the reserved or indicated resource.

For example, the first preset moment is a moment at which a PSFCH corresponding to the fourth transmission or reception resource on which no target object is monitored (or received) if the first terminal fails to monitor (or receive) a target object on four resources indicated by a PSCCH/PSSCH.

It should be noted that, that no target object is monitored or received on the reserved or indicated resource means that the first terminal receives signaling of another terminal, the signaling indicates or reserves some resources, and the another terminal may use these resources, but actually no target object of the another terminal is monitored on these resources.

In some embodiments, in a second case, the first preset moment includes at least one of the following:
A51. Moment related to the latest transmission or reception resource in obtained at least one target resource.

In some embodiments, the first preset moment is a time point determined based on the latest transmission or reception resource in the obtained at least one target resource.
A52. Moment related to a feedback resource corresponding to the latest transmission or reception resource in the obtained at least one target resource.

In some embodiments, the first preset moment is a time point determined based on the feedback resource corresponding to the latest transmission or reception resource in the obtained at least one target resource.

The target resource includes at least one of the following:
a transmission or reception resource reserved or indicated by SCI, a transmission or reception resource indicated by SL DCI, a transmission or reception resource included in SL SPS, or a transmission or reception resource included in an SL CG.

It should be noted that, the target resource is a target resource within the active time, for example, a transmission or reception resource within the active time in the resource included in the SL CG.

Further, the number of transmission or reception resources indicated in a target resource of the latest transmission or reception resources is 1 (that is, no more resources are reserved).

It should be noted herein that, for example, the terminal receives one piece of SCI indicating three transmission or reception resources, and each transmission or reception resource corresponds to one PSFCH moment. PSSCH/PSCCH RX UE feeds back a NACK at PSFCH moments corresponding to the first transmission or reception resource and the second transmission or reception resource. Because the SCI indicates that there is another transmission or reception resource subsequently, the PSSCH/PSCCH RX UE starts the first preset timer only after the third transmission or reception resource is received; or the PSSCH/PSCCHRX UE starts the first preset timer after receiving the third transmission or reception resource and feeding back a NACK on a corresponding PSFCH. For example, a round-trip time timer is started because the PSSCH/PSCCH TX UE does not execute retransmission until a period of time elapses.

In some embodiments, in a third case, the first preset moment includes at least one of the following:
A61. Moment related to the obtained last piece of SCI.

In some embodiments, the first preset moment is a time point determined based on the obtained last piece of SCI.
A62. Moment related to the obtained last piece of SL DCI.

In some embodiments, the first preset moment is a time point determined based on the obtained last piece of SL DCI.
A63. Moment at which the reserved or indicated R^{th} resource is located—n.

Herein, n is a preset value and may be 0, and R is a positive integer and represents any resource. It should be noted that, in this case, in a possible implementation, a length of at least one of the first sub-time domain range or the second sub-time domain range included in the time domain range is determined by RA_duration. For example, the first sub-time domain range is not less than (that is, greater than or equal to) RA_duration, and the second sub-time domain range is not less than RA_duration.

It should be further noted that a length of the second time domain range or the second timer in this embodiment of the present disclosure covers a time of at least one of the following transmission or reception resources obtained by the first terminal:
A71. a transmission or reception resource indicated or reserved by at least one piece of SCI;
A72. a transmission or reception resource indicated by at least one piece of SL DCI;
A73. a transmission or reception resource included in at least one piece of SL SPS; or
A74. a transmission or reception resource included in at least one SL CG.

In this case, it can be ensured that all reserved resources are within the active resource.

That is, timing duration of the second timer or a length of the second time domain range is determined through at least one of the foregoing A71 to A74.

Further, it should be noted that the transmission or reception resource in this embodiment of the present disclosure is an actual transmission or reception resource (actual transmitted resource or actually received resource, that is, transmission or reception is executed at the resource location), a candidate transmission or reception resource (candidate resource, that is, resource transmission or reception may be executed or resource transmission or reception may not be executed at a transmission or reception location), or a reserved transmission or reception resource (reserved resources, that is, resource transmission or reception is not executed at the transmission or reception location).

Further, it should be noted that the transmission or reception resource in this embodiment of the present disclosure may also be interpreted as transmission or reception, for example, actual transmission or reception, candidate transmission or reception, or reserved transmission or reception.

Further, it should be noted that the transmission or reception resource in this embodiment of the present disclosure includes: a transmission or reception used for receiving and/or a transmission or reception used for sending.

Further, it should be noted that the transmission or reception in this embodiment of the present disclosure includes: receiving and/or sending.

It should be noted that an implementation procedure corresponding to this embodiment of the present disclosure may include:
1. UE 1 requests UE 2 to send a CSI-RS, the UE 2 sends the CSI-RS, and the UE 1 feeds back a CSI report (similarly, PSCCH/PSSCH TX UE sends a PSCCH/PSSCH, PSCCH/PSSCH RX UE feeds back a PSFCH, and the PSCCH/PSSCH TX UE monitors the PSFCH and determines whether to execute retransmission or new transmission).

Herein, the UE 1 and the PSCCH/PSSCH RX UE are the foregoing first terminal, and the second terminal is the UE 2 and the PSCCH/PSSCH TX UE.
2. UE 2 sends a CSI-RS and/or the UE 2 requests a CSI report from UE 1, the UE 1 feeds back the CSI report, and then the UE 2 sends or retransmits the CSI-RS (similarly, PSCCH/PSSCH TX UE sends a PSCCH/PSSCH, PSCCH/PSSCH RX UE feeds back a PSFCH, and the PSCCH/PSSCH TX UE monitors the PSFCH and determines whether to execute retransmission or new transmission).

Herein, the UE 2 and the PSCCH/PSSCH RX UE are the foregoing first terminal, and the second terminal is the UE 1 and the PSCCH/PSSCH TX UE.
3. UE 1 feeds back a CSI report, UE2 does not receive or fails to receive the CSI report, and the UE 1 feeds back or retransmits the CSI report (similarly, PSCCH/PSSCH TX UE sends a PSCCH/PSSCH, PSCCH/PSSCH RX UE feeds back a PSFCH, and the PSCCH/PSSCH TX UE monitors the PSFCH and determines whether to execute retransmission or new transmission).

Herein, the UE 1 and the PSCCH/PSSCH RX UE are the foregoing first terminal, and the second terminal is the UE 2 and the PSCCH/PSSCH TX UE.

It should be noted herein that a transmit user of a TB needs to detect a feedback corresponding to the TB, that is, a PSFCH associated with a PSCCH/PSSCH in which the TB is located, and a receive user of the TB needs to send the feedback corresponding to the TB on the associated PSFCH. A user may be a transmit user or a receive user at different moments. That is, the PSSCH/PSCCH TX UE mentioned above is a user sending a PSSCH/PSCCH, the PSFCH TX UE is a user sending a PSFCH, the PSSCH/PSCCH TX UE is a user receiving a PSSCH/PSCCH, and the PSFCH TX UE is a user receiving a PSFCH.

It should be noted that this embodiment of the present disclosure may be applied to a case that PSSCH/PSCCH RX UE monitors SCI, a case that CSI-RS request UE transmits a CSI report, a case that CSI-RS TX UE transmits a CSI-RS, a case that CSI-report request TX UE transmits a CSI-RS, a case that CSI-RS report UE transmits a CSI report, and the like.

It should be further noted that the transmission or reception configuration in this embodiment of the present disclosure may correspond to a resource pool. For example, a resource pool 1 corresponds to a transmission or reception configuration 1, and a resource pool 2 corresponds to a transmission or reception configuration 2.

It should be noted that, in this embodiment of the present disclosure, a terminal executes transmission or reception control in a specified time, thereby avoiding a packet loss of the terminal, reducing energy consumption of the terminal, and improving communication reliability and resource utilization.

As shown in FIG. 7, an embodiment of the present disclosure provides a terminal 700, where the terminal 700 is a first terminal and includes:
a first obtaining module 701, configured to obtain a transmission or reception configuration, where the transmission or reception configuration is used to configure a target parameter; and
a first executing module 702, configured to execute at least one of the following according to the transmission or reception configuration:
executing a sensing control behavior in a time domain range corresponding to the target parameter;
executing a measurement control behavior in the time domain range corresponding to the target parameter;
executing a resource selection or reselection control behavior in the time domain range corresponding to the target parameter; or
executing a transmission or reception control behavior of a target object in the time domain range corresponding to the target parameter, where
the target parameter includes a first preset time domain range or a first preset timer.

In some embodiments, the target object includes at least one of a first request, sidelink control information SCI, a physical sidelink control channel PSCCH, a physical sidelink shared channel PSSCH, a reference signal RS, or a measurement report.

In some embodiments, when the target parameter is the first preset time domain range, the first preset time domain range includes a first time domain range and/or a second time domain range; and when the first executing module 702 executes the sensing control behavior in the time domain range corresponding to the target parameter, the following is implemented:
executing no sensing in the first time domain range, and/or executing sensing in the second time domain range;
or
when the target parameter is the first preset timer, the first preset timer includes a first timer and/or a second timer; and when the first executing module 702 executes the sensing control behavior in the time domain range corresponding to the target parameter, the following is implemented: executing no sensing during running of the first timer, and/or executing sensing during running of the second timer.

In some embodiments, when the target parameter is the first preset time domain range, the first preset time domain range includes a first time domain range and/or a second time domain range; and when the first executing module 702 executes the measurement control behavior in the time domain range corresponding to the target parameter, the following is implemented:
executing no measurement in the first time domain range, and/or executing measurement in the second time domain range;
or
when the target parameter is the first preset timer, the first preset timer includes a first timer and/or a second timer; and when the first executing module 702 executes the measurement control behavior in the time domain range corresponding to the target parameter, the following is implemented: executing no measurement during running of the first timer, and/or executing measurement during running of the second timer.

In some embodiments, when the target parameter is the first preset time domain range, the first preset time domain range includes a first time domain range and/or a second time domain range; and when the first executing module 702 executes the resource selection or reselection control behavior in the time domain range corresponding to the target parameter, at least one of the following is implemented
executing no resource selection or reselection in the first time domain range;
executing resource selection or reselection in the second time domain range;
not selecting or reselecting, by the first terminal, a resource in the first time domain range; or
selecting or reselecting, by the first terminal, a resource in the second time domain range;
or
when the target parameter is the first preset timer, the first preset timer includes a first timer and/or a second timer; and when the first executing module 702 executes the resource selection or reselection control behavior in the time domain range corresponding to the target parameter, at least one of the following is implemented:
executing no resource selection or reselection during running of the first timer;
executing resource selection or reselection during running of the second timer;
not selecting or reselecting, by the first terminal, a resource during running of the first timer; or
selecting or reselecting, by the first terminal, a resource during running of the second timer.

In some embodiments, when the target parameter is the first preset time domain range, the first preset time domain range includes a first time domain range and/or a second time domain range; and when the first executing module 702 executes the transmission or reception control behavior of the target object in the time domain range corresponding to the target parameter, the following is implemented:
not monitoring or receiving, by the first terminal, the target object in the first time domain range, and/or monitoring or receiving, by the first terminal, the target object in the second time domain range;
or
when the target parameter is the first preset timer, the first preset timer includes a first timer and/or a second timer; and when the first executing module 702 executes the transmission or reception control behavior of the target object in the time domain range corresponding to the target parameter, the following is implemented: not monitoring or receiving, by the first terminal, the target object during running of the first timer, and/or monitoring or receiving, by the first terminal, the target object during running of the second timer.

Further, when the time domain range includes a first sub-time domain range and/or a second sub-time domain range, a length of at least one of the first sub-time domain range or the second sub-time domain range is greater than or equal to at least one of the following parameters:
a packet delay budget PDB;
32 slots;

M×P, where P is a reservation period, a service period, a period indicated by sidelink control information SCI, a period of a sidelink configured grant (SL CG), or a period of sidelink semi-persistent scheduling, and M is a positive integer; and

J slots or milliseconds, where J is greater than or equal to 32+N and is less than or equal to 32+N+K−1, or J is greater than or equal to RA_duration+N and is less than or equal to RA_duration+N+K−1, N is a period of a feedback resource, K is a minimum time interval between a transmission or reception resource and a corresponding feedback resource, RA_duration is a time domain range or a time domain distance occupied by two transmission or reception resources in preset transmission or reception resources, and the preset transmission or reception resource is a transmission or reception resource included in SL SPS, a transmission or reception resource included in an SL CG, a transmission or reception resource scheduled by SL DCI, or a transmission or reception resource indicated by SCI, where
when the target parameter is the first preset timer, and the first preset timer includes a first timer and/or a second timer, the first sub-time domain range corresponds to timing duration of the first timer, and the second sub-time domain range corresponds to timing duration of the second timer; and
when the target parameter is the first preset time domain range and the first preset time domain range includes a first time domain range and/or a second time domain range, the first sub-time domain range corresponds to the first time domain range, and the second sub-time domain range corresponds to the second time domain range.

In some embodiments, the terminal further includes:
a third obtaining module, configured to obtain a first target moment, where the first target moment is a first preset moment, or the first target moment is a moment when the first preset moment is shifted by a first offset; and
the first target moment is a start point of the time domain range.

Further, when the target parameter is the first preset timer, after the third obtaining module obtains the first target moment, the terminal further includes:
a first starting module, configured to start the first preset timer at the first target moment.

In some embodiments, the first preset moment includes at least one of the following:
a moment at which a resource is preempted;
a moment at which the last transmission or reception resource is located;
a moment related to receiving the last transmission or reception resource;
a moment at which a feedback resource corresponding to the first transmission or reception resource is located;
a moment at which a feedback resource corresponding to the last transmission or reception resource is located;
a moment at which a feedback resource is sent;
a moment at which a first response is sent;
a moment at which a physical uplink control channel PUCCH or a physical uplink shared channel PUSCH is sent;
a moment related to sending a negative acknowledgment;
a moment related to sending no first response;
a moment related to sending no feedback resource;
a moment at which a transmission or reception resource on which no target object is monitored or received is located when no target object is monitored or received on a reserved or indicated resource; or
a moment at which a feedback resource corresponding to the transmission or reception resource on which no target object is monitored or received is located when no target object is monitored or received on the reserved or indicated resource.

Further, the moment at which the feedback resource is sent includes: a moment at which the A^{th} feedback resource is sent or a moment at which the feedback resource corresponding to the last transmission or reception resource is sent, where
A is a positive integer.

Further, the moment related to the case that the negative acknowledgment is sent includes at least one of the following:
a moment related to sending the first negative acknowledgment;
a moment related to sending each negative acknowledgment; or
a moment related to a case that the last feedback resource is sent and feedback content is a negative acknowledgment.

Further, the moment related to the case that no feedback resource is sent includes at least one of the following:
a moment related to sending no feedback resource for the first time;
a moment related to sending no feedback resource each time; or
a moment related to not sending the last feedback resource if all feedback resources are not sent.

Further, the moment at which the transmission or reception resource on which no target object is monitored or received is located when no target object is monitored or received on the reserved or indicated resource includes:
a moment at which the last transmission or reception resource on which no target object is monitored or received is located when no target object is monitored or received on the reserved or indicated resource.

Further, the moment at which the feedback resource corresponding to the transmission or reception resource on which no target object is monitored or received is located when no target object is monitored or received on the reserved or indicated resource includes:
a moment at which a feedback resource corresponding to the last transmission or reception resource on which no target object is monitored or received is located when no target object is monitored or received on the reserved or indicated resource.

In some embodiments, the first preset moment includes at least one of the following:
a moment related to the latest transmission or reception resource in obtained at least one target resource; or
a moment related to a feedback resource corresponding to the latest transmission or reception resource in the obtained at least one target resource, where
the target resource includes at least one of the following:
a transmission or reception resource reserved or indicated by sidelink control information SCI, a transmission or reception resource indicated by sidelink downlink control information SL DCI, a transmission or reception resource included in sidelink semi-persistent scheduling SL SPS, or a transmission or reception resource included in a sidelink configured grant (SL CG).

In some embodiments, the target resource is a target resource in the active time.

In some embodiments, the first preset moment includes at least one of the following:
a moment related to the obtained last piece of sidelink control information SCI;
a moment related to the obtained last piece of sidelink downlink control information SL DCI; or
a moment at which the reserved or indicated R^{th} resource is located—n, where
n is a preset value.

In some embodiments, a length of the second time domain range or the second timer covers a time of at least one of the following transmission or reception resources obtained by the first terminal:
a transmission or reception resource indicated or reserved by at least one piece of sidelink control information SCI;
a transmission or reception resource indicated by at least one piece of sidelink downlink control information SL DCI;
a transmission or reception resource included in at least one piece of sidelink semi-persistent scheduling SL SPS; or
a transmission or reception resource included in at least one sidelink configured grant (SL CG).

In some embodiments, the transmission or reception configuration is a possible sidelink discontinuous reception DRX configuration.

It should be noted that the terminal embodiment is the terminal corresponding to the foregoing transmission or reception configuration method performed by the first terminal. All implementations of the foregoing embodiment are applicable to the terminal embodiment, and a same technical effect can also be achieved.

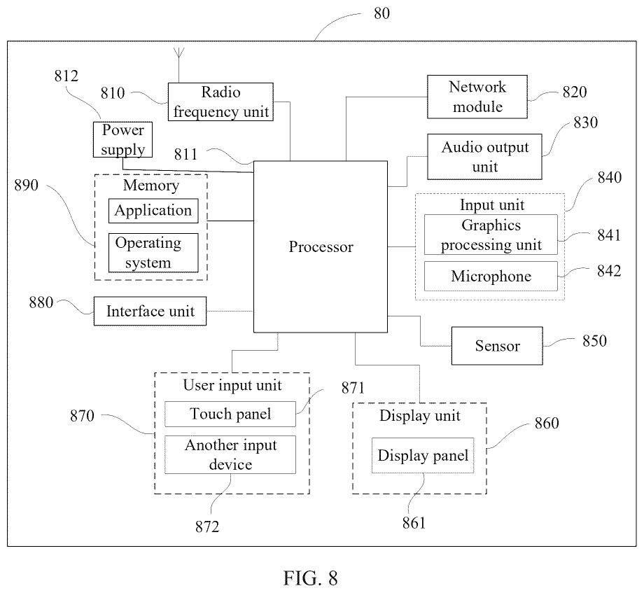

FIG. 8 is a schematic diagram of a hardware structure of a terminal according to an embodiment of the present disclosure.

The terminal 80 is a first terminal, and includes but is not limited to components such as a radio frequency unit 810, a network module 820, an audio output unit 830, an input unit 840, a sensor 850, a display unit 860, a user input unit 870, an interface unit 880, a memory 890, a processor 811, and a power supply 812. It can be understood by a person skilled in the art that, the terminal structure shown in FIG. 8 does not constitute any limitation on the terminal, and the terminal may include more or fewer components than those shown in the figure, or combine some components, or have different component arrangements. In this embodiment of the present disclosure, the terminal includes but is not limited to a mobile phone, a tablet computer, a notebook computer, a palmtop computer, an in-vehicle terminal, a wearable device, a pedometer, and the like.

The processor 811 is configured to: obtain a transmission or reception configuration, where the transmission or reception configuration is used to configure a target parameter; and execute at least one of the following according to the transmission or reception configuration:
executing a sensing control behavior in a time domain range corresponding to the target parameter;
executing a measurement control behavior in the time domain range corresponding to the target parameter;
executing a resource selection or reselection control behavior in the time domain range corresponding to the target parameter; or
executing a transmission or reception control behavior of a target object in the time domain range corresponding to the target parameter, where
the target parameter includes a first preset time domain range or a first preset timer.

According to the terminal in this embodiment of the present disclosure, behaviors that meet requirements are executed in a time domain range corresponding to a target parameter according to a transmission or reception configuration, thereby limiting a transmission or reception behavior of the terminal, avoiding packet removal, and improving communication reliability and resource utilization.

It should be understood that, in this embodiment of the present disclosure, the radio frequency unit 810 may be configured to receive and send information or a signal in a call process. In some embodiments, after receiving downlink data from a network side device, the radio frequency unit 810 sends the downlink data to the processor 811 for processing. In addition, the radio frequency unit 810 sends uplink data to the network side device. Usually, the radio frequency unit 810 includes but is not limited to an antenna, at least one amplifier, a transceiver, a coupler, a low noise amplifier, a duplexer, and the like. In addition, the radio frequency unit 810 may communicate with a network and another device through a wireless communication system.

The terminal provides wireless broadband Internet access for the user by using the network module 820, for example, helping the user to send and receive an e-mail, browse a web page, and access streaming media.

The audio output unit 830 may convert audio data received by the radio frequency unit 810 or the network module 820 or stored in the memory 890 into an audio signal and output the audio signal as a sound. In addition, the audio output unit 830 may further provide an audio output (for example, a call signal received voice, or a message received voice) related to a specific function implemented by the terminal 80. The audio output unit 830 includes a speaker, a buzzer, a telephone receiver, and the like.

The input unit 840 is configured to receive an audio signal or a video signal. The input unit 840 may include a Graphics Processing Unit (GPU) 841 and a microphone 842, and the graphics processing unit 841 processes image data of a still picture or video obtained by an image capture apparatus (such as a camera) in a video capture mode or an image capture mode. A processed image frame may be displayed on the display unit 860. The image frame processed by the graphics processing unit 841 may be stored in the memory 890 (or another storage medium) or sent by using the radio frequency unit 810 or the network module 820. The microphone 842 may receive a sound and can process such sound into audio data. Processed audio data may be converted, in a call mode, into a format that can be sent to a mobile communication network side device by using the radio frequency unit 810 for output.

The terminal 80 further includes at least one type of sensor 850, such as a light sensor, a motion sensor, and another sensor. In some embodiments, the light sensor includes an ambient light sensor and a proximity sensor. The ambient light sensor may adjust luminance of the display panel 861 based on brightness of ambient light. The proximity sensor may turn off the display panel 861 and/or backlight when the terminal 80 moves to an ear. As a type of the motion sensor, an accelerometer sensor may detect an acceleration value in each direction (generally, three axes), and detect a value and a direction of gravity when the accelerometer sensor is static, and may be used for recognizing a terminal posture (such as screen switching between landscape and portrait modes, a related game, or magnetometer posture calibration), a function related to vibration recognition (such as a pedometer or a knock), and the like. The sensor 850 may further include a fingerprint sensor, a pressure sensor, an iris sensor, a molecular sensor, a gyroscope, a barometer, a hygrometer, a thermometer, an infrared sensor, and the like. Details are not described herein.

The display unit 860 is configured to display information entered by a user or information provided for a user. The display unit 860 may include a display panel 861. The display panel 861 may be configured in a form of a Liquid Crystal Display (LCD), an Organic Light-Emitting Diode (OLED), or the like.

The user input unit 870 may be configured to receive input numeral or character information, and generate key signal input related to user setting and functional control of the terminal. In some embodiments, the user input unit 870 includes a touch panel 871 and another input device 872. The touch panel 871 is also referred to as a touchscreen, and may collect a touch operation executed by a user on or near the touch panel 871 (such as an operation executed by a user on the touch panel 871 or near the touch panel 871 by using any proper object or accessory, such as a finger or a stylus). The touch panel 871 may include two parts: a touch sensing apparatus and a touch controller. The touch sensing apparatus detects a touch position of the user, detects a signal brought by the touch operation, and sends the signal to the touch controller. The touch controller receives touch information from the touch sensing apparatus, converts the touch information into touch point coordinates, and sends the touch point coordinates to the processor 811, and can receive and execute a command sent by the processor 811. In addition, the touch panel 871 may be of a resistive type, a capacitive type, an infrared type, a surface acoustic wave type, or the like. The user input unit 870 may include another input device 872 in addition to the touch panel 871. In some embodiments, the another input device 872 may include but is not limited to a physical keyboard, a functional button (such as a volume control button or a power on/off button), a trackball, a mouse, and a joystick. Details are not described herein.

Further, the touch panel 871 may cover the display panel 861. When detecting the touch operation on or near the touch panel 871, the touch panel 871 transmits the touch operation to the processor 811 to determine a type of a touch event, and then the processor 811 provides corresponding visual output on the display panel 861 based on the type of the touch event. In FIG. 8, although the touch panel 871 and the display panel 861 are used as two independent parts to implement input and output functions of the terminal, in some embodiments, the touch panel 871 and the display panel 861 may be integrated to implement the input and output functions of the terminal. This is not In some embodiments limited herein.

The interface unit 880 is an interface for connecting an external apparatus with the terminal 80. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, a headset port, and the like. The interface unit 880 may be configured to receive input (for example, data information and power) from an external apparatus and transmit the received input to one or more elements in the terminal 80 or may be configured to transmit data between the terminal 80 and an external apparatus.

The memory 890 may be configured to store a software program and various data. The memory 890 may mainly include a program storage area and a data storage area. The program storage area may store an operating system, an application program required by at least one function (such as a sound play function or an image play function), and the like. The data storage area may store data (such as audio data or an address book) created based on use of the mobile phone, and the like. In addition, the memory 890 may include a high-speed random access memory, and may further include a nonvolatile memory, for example, at least one magnetic disk storage device, a flash storage device, or another volatile solid-state storage device.

The processor 811 is a control center of the terminal, and connects all parts of the entire terminal by using various interfaces and lines. By running or executing a software program and/or a module stored in the memory 890 and invoking data stored in the memory 890, the processor 811 performs various functions of the terminal and data processing, to perform overall monitoring on the terminal. The processor 811 may include one or more processing units. In some embodiments, an application processor and a modem processor may be integrated into the processor 811. The application processor mainly processes an operating system, a user interface, an application, and the like. The modem processor mainly processes wireless communications. It can be understood that the modem processor may not be integrated into the processor 811.

The terminal 80 may further include the power supply 812 (such as a battery) that supplies power to each component. In some embodiments, the power supply 812 may be logically connected to the processor 811 by using a power management system, so as to implement functions such as charging, discharging, and power consumption management by using the power management system.

In addition, the terminal 80 includes some function modules not shown, and details are not described herein.

It should be further noted that the processor 810 is further configured to implement other processes in the transmission or reception configuration method performed by the first terminal in the foregoing embodiment, and details are not described herein again.

An embodiment of the present disclosure further provides a terminal, including a processor 811, a memory 890, and a computer program that is stored in the memory 890 and that can be run on the processor 811. When the computer program is executed by the processor 811, the foregoing processes of the transmission or reception configuration method embodiment performed by the first terminal side are implemented and a same technical effect can be achieved. To avoid repetition, details are not described herein again.

An embodiment of the present disclosure further provides a computer-readable storage medium. The computer-readable storage medium stores a computer program, and when the computer program is executed by a processor, the foregoing processes of the transmission or reception configuration method embodiment performed by the first terminal side are implemented and a same technical effect can be achieved. To avoid repetition, details are not described herein again. The computer-readable storage medium includes a Read-Only Memory (ROM), a Random Access Memory (RAM), a magnetic disk, or an optical disc.

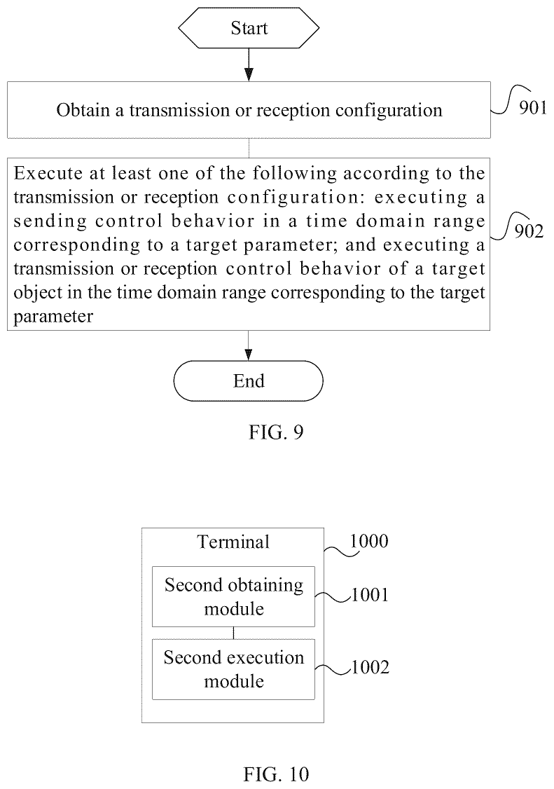

As shown in FIG. 9, an embodiment of the present disclosure provides a transmission or reception configuration method, performed by a second terminal and including:
Step 901: Obtain a transmission or reception configuration.

It should be noted that the transmission or reception configuration is used to configure a target parameter. In some embodiments, the target parameter includes a second preset time domain range or a second preset timer.
Step 902: Execute at least one of the following according to the transmission or reception configuration:
B11. executing a sending control behavior in a time domain range corresponding to the target parameter; or
B12. executing a transmission or reception control behavior of a target object in the time domain range corresponding to the target parameter.

It should be noted that the time domain range mentioned in this embodiment of the present disclosure may be interpreted as a time window or a time domain resource set. The time domain resource set includes at least one time domain resource. If the set includes a plurality of time domain resources, these resources may be consecutive or discrete in time domain. For example, the time domain range includes at least one sidelink slot.

Specific implementations of B11 and B12 are described in detail below from perspectives of different target parameters.

### 1. B11

It should be noted that when the target parameter is the second preset time domain range, the second preset time domain range includes a third time domain range and/or a fourth time domain range. In some embodiments, an implementation of B11 includes at least one of the following:
B111. Execute no sending in the third time domain range.

It should be noted that, in this case, the second terminal does not send a resource in the third time domain range.
B112. Execute sending in the fourth time domain range.

It should be noted that, in this case, the second terminal may send a resource in the fourth time domain range, but it is not specified that the second terminal certainly sends a resource in the fourth time domain range in this case.

It should be noted that when the target parameter is the second preset timer, the second preset timer includes a third timer and/or a fourth timer. It should be noted that the third timer may be at least one of a round-trip time timer (RTT timer), a waiting timer, an off timer, a sleep timer, or the like, and the fourth timer may be at least one of a retransmission timer (ReTX timer), an inactivity timer, an on duration timer, a measurement timer, a report timer, a response timer, or the like.

Further, an implementation of B11 includes at least one of the following:
B113. Execute no sending during running of the third timer.

It should be noted that, in this case, the second terminal does not send a resource during running of the third timer.
B114. Execute sending during running of the fourth timer.

It should be noted that, in this case, the second terminal may send a resource during running of the fourth timer, but it is not specified that the second terminal certainly sends a resource during running of the fourth timer in this case.

### 2. B12

First, it should be noted that the target object includes at least one of a synchronization request, a reference signal request, a first request, sidelink control information (SCI), a physical sidelink control channel (PSCCH), a physical sidelink shared channel (PSSCH), a reference signal (RS), or a measurement report.

In some embodiments, the first request may include at least one of a measurement report request (for example, at least one of a CSI report request, an RSRP report request, an RSRQ report request, or an RSSI report request), a connection establishment request, a connection resume request, a link resume request, a link re-establishment request, a reconfiguration request, a retransmission request, or the like.

The reference signal may include at least one of a CSI-RS, a PT-RS, an SRS, a PRS, or the like.

The measurement report may be, for example, at least one of a channel state information report (CSI report), a reference signal received power report (RSRP report), a reference signal received quality report (RSRQ report), or a received signal strength indicator report (RSSI report).

It should be noted that when the target parameter is the second preset time domain range, the domain range includes a third time domain range and/or a fourth time domain range.

Further, an implementation of B12 includes at least one of the following:
B121. The second terminal does not send the target object in the third time domain range.

For example, the second terminal does not send a PSCCH in the third time domain range.
B122. The second terminal sends the target object in the fourth time domain range.

For example, the second terminal sends a reference signal in the fourth time domain range.

It should be noted that when the target parameter is the second preset timer, the second preset timer includes a third timer and/or a fourth timer. It should be noted that the third timer may be at least one of a round-trip time timer (RTT timer), a waiting timer, an off timer, a sleep timer, or the like, and the fourth timer may be at least one of a retransmission timer (ReTX timer), an inactivity timer, an on duration timer, a measurement timer, a report timer, a response timer, or the like.

Further, an implementation of B12 includes at least one of the following:
B123. The second terminal does not send the target object during running of the third timer.

For example, the second terminal does not send a PSCCH during running of a round-trip time timer.
B124. The second terminal sends the target object during running of the fourth timer.

For example, the second terminal sends a reference signal during running of a retransmission timer.

It should be noted that, for the implementation of step 902, time domain ranges or timers of different lengths may be designed for different implementations, or time domain ranges or timers of a same length may be designed for different implementations.

Further, it should be noted that the transmission or reception configuration in this embodiment of the present disclosure may restrict receiving and/or sending. When the transmission or reception configuration restricts at least receiving of a terminal, the transmission or reception configuration may be considered as a sidelink discontinuous reception (DRX) configuration.

In some embodiments, the transmission or reception configuration is obtained in at least one of the following manners:
B21. being configured by a network side device;
B22. being preconfigured;
B23. being stipulated in a protocol;
B24. being indicated by another terminal; or
B25. being determined by the second terminal.

That is, the transmission or reception configuration may be configured or preconfigured by the second terminal through a protocol, obtained by another terminal, negotiated by the second terminal and a first terminal, notified by the second terminal to the first terminal, or notified by the first terminal to the second terminal.

Further, it should be noted that, when the target parameter is the second preset time domain range or the second preset timer, and the time domain range includes a third sub-time domain range and/or a fourth sub-time domain range, a length of at least one of the third sub-time domain range or the fourth sub-time domain range is greater than or equal to at least one of the following parameters:
B31. Packet delay budget (PDB).
B32. 32 slots.

In some embodiments, the 32 slots herein may be 32 sidelink slots or 32 physical slots.
B33. M×P (that is, M times P).

It should be noted that P is a reservation period, a service period, a period indicated by SCI, a period of an SL CG, or a period of SL SPS, Mis a positive integer, and M is configured or preconfigured by a network side device, stipulated in a protocol, or indicated by another terminal.
B34. J slots or milliseconds.

It should be noted that J is greater than or equal to 32+N and is less than or equal to 32+N+K−1 (that is, J belongs to an interval [32+N, 32+N+K−1]), or J is greater than or equal to RA_duration+N and is less than or equal to RA_duration+N+K−1 (that is, J belongs to an interval [RA_duration+N, RA_duration+N+K−1]).

It should be noted that some of the foregoing interval representations are a logical time, and some are a physical time. For example, N and K are the number of sidelink slots, and RA_duration may be the number of sidelink slots, or may be the number of physical slots. If units are different, the parameters need to be converted into results corresponding to a same unit.

In some embodiments, N is a period of a feedback resource, K is a minimum time interval between a transmission or reception resource and a corresponding feedback resource, and RA_duration is a time domain range or a time domain distance occupied by two transmission or reception resources in preset transmission or reception resource. In some embodiments, RA_duration is a time domain range or a time domain distance occupied by the first transmission or reception resource and the last transmission or reception resource in the preset transmission or reception resources. In some embodiments, the time domain range is a physical time domain range or a logical time domain range. The time domain distance is a physical time domain distance or a logical time domain distance.

For example, if physical slots 2 and 4 in physical slots 1, 2, 3, 4, and 5 are used for a sidelink, the physical slots 2 and 4 correspond to sidelink slots 1 and 2. Therefore, a logical time domain distance between sidelink slots is one sidelink slot, and a physical time domain distance is two slots.

It should be noted herein that when the number of preset transmission or reception resources is 1, RA_duration=0 or 1.

In some embodiments, it should be further noted that the preset transmission or reception resource is a transmission or reception resource included in SL SPS, a transmission or reception resource included in an SL CG, a transmission or reception resource scheduled by SL DCI, or a transmission or reception resource indicated by SCI.

For the foregoing case, when the target parameter is the second preset timer, and the second preset timer includes a third timer and/or a fourth timer, the third sub-time domain range corresponds to timing duration of the third timer, and the fourth sub-time domain range corresponds to timing duration of the fourth timer; and
when the target parameter is the second preset time domain range and the time domain range includes a third time domain range and/or a fourth time domain range, the third sub-time domain range corresponds to the third time domain range, and the fourth sub-time domain range corresponds to the fourth time domain range.

Further, it should be further noted that, regardless of whether the target parameter is the second preset time domain range or the target parameter is the second preset timer, the transmission or reception configuration method in this embodiment of the present disclosure further includes:
obtaining a second target moment, where the second target moment is a second preset moment, or the second target moment is a moment when the second preset moment is shifted by a second offset (that is, second target moment=second preset moment+second offset); and
the second target moment is a start point of the time domain range.

In some embodiments, the second offset is obtained in any one of B21 to B25.

Further, it should be noted that when the target parameter is the second preset timer, after the obtaining a second target moment, the method further includes:
starting the second preset timer at the second target moment.

Further, it should be noted herein that a condition for starting the second preset timer may be: starting the second preset timer starting from the second target moment, or starting the second preset timer after the second target moment.

Further, when the second preset timer includes a third timer or a fourth timer, a second target moment of the third timer is different from a second target moment of the fourth timer. Because a second target moment is mainly determined by a second preset moment, that is, when both the third timer and the fourth timer are included in this embodiment of the present disclosure, start moments of the third timer and the fourth timer are different.

Further, it should be noted that when the target parameter is the second preset time domain range and the second preset time domain range includes a third time domain range or a fourth time domain range, a second target moment of the third time domain range is different from a second target moment of the fourth time domain range. That is, when both the third time domain range and the fourth time domain range are included in this embodiment of the present disclosure, start moments of the third time domain range and the fourth time domain range are different.

In some embodiments, in a first case, the second preset moment includes at least one of the following:
B401. Moment at which a resource is preempted.

It should be noted that, the preempted resource herein is a resource indicated or reserved by another terminal, or the preempted resource is an expected transmission or reception resource that is preempted.
B402. Moment at which the last transmission or reception resource is located.

For example, one piece of SCI indicates (reserves) three transmission or reception resources, and a moment at which the third transmission or reception resource is located is the second preset moment. For example, the second preset timer is started at the moment at which the third transmission or reception resource is located.
B403. Moment related to sending the last transmission or reception resource.

In some embodiments, the last transmission or reception resource may be a PSSCH resource and/or a PSCCH resource. In some embodiments, the second preset moment is a time point determined by the case that the last transmission or reception resource is sent. For example, the second preset moment is a moment when the last transmission or reception resource is sent or after the last transmission or reception resource is sent.
B404. Moment at which a feedback resource corresponding to the first transmission or reception resource is located.

In some embodiments, the feedback resource is a PSFCH. That is, in this case, the first preset moment is a moment at which a PSFCH corresponding to the first transmission or reception resource is located.
B405. Moment at which a feedback resource corresponding to the last transmission or reception resource is located.

In some embodiments, the feedback resource is a PSFCH. That is, in this case, the first preset moment is a moment at which a PSFCH corresponding to the last transmission or reception resource is located.

For example, one piece of SCI indicates (reserves) three transmission or reception resources, and a moment at which a PSFCH corresponding to the third transmission or reception resource is located is the second preset moment. For example, the second preset timer is started at the moment at which the PSFCH corresponding to the third transmission or reception resource is located.
B406. Moment at which a feedback resource is received or monitored.

In some embodiments, the moment at which the feedback resource is received or monitored includes: a moment at which the A^{th} feedback resource is received or monitored; or
a moment at which the feedback resource corresponding to the last transmission or reception resource is received or monitored, where
A is a positive integer, and A represents any feedback resource.

In some embodiments, the feedback resource is a PSFCH. For example, in this case, the receiving (or monitoring) a PSFCH may be receiving (or monitoring) the first PSFCH for a TB, or may be receiving (or monitoring) the Yth PSFCH for a TB, or may be receiving (or monitoring) a PSFCH corresponding to the last transmission or reception resource (for example, a PSSCH resource and/or a PSCCH resource) for a TB.
B407. Moment at which a first response is received or monitored

In some embodiments, the first response may include a response to at least one of a synchronization request, a connection establishment request, a connection resume request, a link resume request, a link re-establishment request, a reconfiguration request, a retransmission request, or the like, for example, at least one of allowing or succeeding in synchronization, allowing or succeeding in establishing a connection, allowing or succeeding in resuming a connection, allowing or succeeding in resuming a link, allowing or succeeding in re-establishing a link, reconfiguring, or retransmitting, where the allowing or succeeding in synchronization may include at least one of allowing or succeeding being as synchronization reference, allowing or succeeding in transmitting a synchronization signal, or the like.

The reference signal may include at least one of a CSI-RS, a PT-RS, an SRS, a PRS, or the like.

The measurement report may be, for example, at least one of a channel state information report (CSI report), a reference signal received power report (RSRP report), a reference signal received quality report (RSRQ report), a received signal strength indicator report (RSSI report), or a PT-RS measurement report.
B408. Moment at which a PUCCH or a PUSCH is sent.
B409. Moment related to receiving or monitoring a negative acknowledgment.

In some embodiments, the second preset moment is a time point determined based on the case that the negative acknowledgment is received or monitored. For example, the second preset moment is a moment when the negative acknowledgment is received (or monitored), or the second preset moment is a moment after the negative acknowledgment is received (or monitored).

It should be noted that, this herein is a case that a NACK is received (or monitored).

Further, it should be noted that this case includes at least one of the following:
B4091. Moment related to receiving or monitoring the first negative acknowledgment.

In some embodiments, the second preset moment is a time point determined based on the case that the first negative acknowledgment is received or monitored. For example, in this case, the first preset moment is a moment at which the first NACK for a TB is received (or monitored).
B4092. Moment related to receiving or monitoring each negative acknowledgment.

In some embodiments, the second preset moment is a time point determined based on the case that the first negative acknowledgment is received or monitored. For example, in this case, the first preset moment is a moment at which each NACK for a TB is received (or monitored).
B4093. Moment related to a case that the last feedback resource is received or monitored and feedback content is a negative acknowledgment.

For example, in this case, the second preset moment is a moment at which the last PSFCH is received (or monitored) and feedback content in the PSFCH is a NACK.
B410. Moment related to receiving or monitoring no first response.

In some embodiments, the second preset moment is a time point determined based on the case that no first response is received or monitored.

It should be noted that there are two cases in which the second terminal execute no receiving (or monitoring):
Case 1: The second terminal does not execute receiving (or monitoring) at all. For example, there is another transmission or reception of a higher priority. Therefore, original receiving (or monitoring) is canceled.
Case 1: The second terminal actually attempts to execute receiving (or monitoring), but fails in receiving (or monitoring). For example, because a peer end does not execute sending, the second terminal fails in receiving (or monitoring).

Further, it should be noted that this case includes at least one of the following:
B4101. Moment related to receiving or monitoring no first response for the first time.

In some embodiments, the second preset moment is a time point determined based on the case that no first response is received or monitored for the first time. For example, in this case, the second preset moment is a moment at which no first response for a TB is received (or monitored) for the first time.
B4102. Moment related to receiving or monitoring no first response each time.

In some embodiments, the second preset moment is a time point determined based on the case that no first response is received or monitored each time. For example, in this case, the second preset moment is a moment at which no first response for a TB is received (or monitored) each time.
B4103. Moment related to not receiving or monitoring the last first response if all first responses are not received or monitored.

In some embodiments, the second preset moment is a time point determined based on the case that the last first response is not received or monitored if all first responses are not received or monitored. For example, in this case, the second preset moment starts from a moment at which the last first response is not received (or monitored) if all first responses for a TB are not received (or monitored).
B411. Moment related to receiving or monitoring no feedback resource.

In some embodiments, the second preset moment is a time point determined based on the case that no feedback resource is received or monitored. In some embodiments, the feedback resource is a PSFCH.

It should be noted that there are two cases in which the second terminal execute no receiving (or monitoring):
Case 1: The second terminal does not execute receiving (or monitoring) at all. For example, there is another transmission or reception of a higher priority. Therefore, the original receiving (or monitoring) is canceled.
Case 1: The second terminal actually attempts to execute receiving (or monitoring), but fails in receiving (or monitoring). For example, because a peer end does not execute sending, the second terminal fails in receiving (or monitoring).

Further, it should be noted that this case includes at least one of the following:
B4111. Moment related to receiving or monitoring no feedback resource for the first time.

In some embodiments, in this case, a PSFCH for a TB is not received (or monitored) for the first time.
B4112. Moment related to receiving or monitoring no feedback resource each time.

In some embodiments, in this case, a PSFCH for a TB is not received (or monitored) each time.
B4113. Moment related to not receiving or monitoring the last feedback resource if all feedback resources are not received or monitored.

In some embodiments, in this case, the second preset moment starts from a moment at which the last PSFCH is not received (or monitored) if all PSFCHs for a TB are not received (or monitored).
B412. Moment at which a transmission or reception resource on which no target object is sent is located when no target object is sent on a reserved or indicated resource.

In this case, the second preset moment is a moment at which the last transmission or reception resource on which no target object is sent is located when no target object is sent on the reserved or indicated resource.

For example, a moment at which the third transmission or reception resource on which no target object is sent is located is determined as the second preset moment if the second terminal does not send a target object on three resources indicated by a PSCCH/PSSCH.
B413. Moment at which a feedback resource corresponding to the transmission or reception resource on which no target object is sent is located when no target object is sent on the reserved or indicated resource.

In this case, the second preset moment is a moment at which the feedback resource corresponding to the last transmission or reception resource on which no target object is sent is located when no target object is sent on the reserved or indicated resource.

For example, a moment at which a PSFCH corresponding to the fourth transmission or reception resource on which no target object is sent is located is determined as the second preset moment if the second terminal does not send a target object on four resources indicated by a PSCCH/PSSCH.

It should be noted that, the reserved or indicated resource means that the second terminal receives signaling of another terminal, the signaling indicates or reserves some resources, and the another terminal may use these resources, but actually no target object of the another terminal is sent on these resources.

In some embodiments, in a second case, the second preset moment includes at least one of the following:
B51. Moment related to the latest transmission or reception resource in obtained at least one target resource.

In some embodiments, the second preset moment is a time point determined based on the latest transmission or reception resource in the obtained at least one target resource.
B52. Moment related to a feedback resource corresponding to the latest transmission or reception resource in the obtained at least one target resource.

In some embodiments, the second preset moment is a time point determined based on the feedback resource corresponding to the latest transmission or reception resource in the obtained at least one target resource.

The target resource includes at least one of the following:
a transmission or reception resource reserved or indicated by SCI, a transmission or reception resource indicated by SL DCI, a transmission or reception resource included in SL SPS, or a transmission or reception resource included in an SL CG.

It should be noted that, the target resource is a target resource within the active time.

Further, the number of transmission or reception resources indicated in a target resource of the latest transmission or reception resources is 1 (that is, no more resources are reserved).

In some embodiments, in a third case, the second preset moment includes at least one of the following:
B61. Moment related to the sent last piece of SCI.

In some embodiments, the second preset moment is a time point determined based on the sent last piece of SCI.
B62. Moment related to the obtained last piece of SL DCI.

In some embodiments, the second preset moment is a time point determined based on the obtained last piece of SL DCI.
B63. Moment at which the reserved or indicated R^{th} resource is located—n.

In this case, n is a preset value and may be 0, and R is a positive integer and represents any resource. It should be noted that, in this case, a length of at least one of the third sub-time domain range or the fourth sub-time domain range included in the time domain range is determined by RA_duration. For example, the third sub-time domain range is not less than (that is, greater than or equal to) RA_duration, and the fourth sub-time domain range is not less than RA duration.

It should be further noted that a length of the fourth time domain range or the fourth timer in this embodiment of the present disclosure covers a time of at least one of the following transmission or reception resources obtained by the second terminal:
B71. a transmission or reception resource indicated or reserved by at least one piece of SCI;
B72. a transmission or reception resource indicated by at least one piece of SL DCI;
B73. a transmission or reception resource included in at least one piece of SL SPS; and
B74. a transmission or reception resource included in at least one SL CG.

Further, it should be noted that the transmission or reception resource in this embodiment of the present disclosure is an actual transmission or reception resource (that is, transmission or reception is executed at the resource location), a candidate transmission or reception resource (that is, resource transmission or reception may be executed or resource transmission or reception may not be executed at a transmission or reception location), or a reserved transmission or reception resource (that is, resource transmission or reception is not executed at the transmission or reception location).

It should be noted that this embodiment of the present disclosure imposes a limitation on PSCCH/PSSCH TX UE.

It should be further noted that the transmission or reception configuration in this embodiment of the present disclosure may correspond to a resource pool. For example, a resource pool 1 corresponds to a transmission or reception configuration 1, and a resource pool 2 corresponds to a transmission or reception configuration 2.

It should be noted that, in this embodiment of the present disclosure, a terminal executes transmission or reception control in a specified time, thereby avoiding a packet loss of the terminal, reducing energy consumption of the terminal, and improving communication reliability and resource utilization.

As shown in FIG. 10, an embodiment of the present disclosure provides a terminal 1000, where the terminal 1000 is a second terminal and includes:
a second obtaining module 1001, configured to obtain a transmission or reception configuration, where the transmission or reception configuration is used to configure a target parameter; and
a second executing module 1002, configured to execute at least one of the following:
executing a sending control behavior in a time domain range corresponding to the target parameter; or
executing a transmission or reception control behavior of a target object in the time domain range corresponding to the target parameter, where
the target parameter includes a second preset time domain range or a second preset timer.

In some embodiments, the target object includes at least one of a first request, sidelink control information SCI, a physical sidelink control channel PSCCH, a physical sidelink shared channel PSSCH, a reference signal RS, or a measurement report.

In some embodiments, when the target parameter is the second preset time domain range, the second preset time domain range includes a third time domain range and/or a fourth time domain range; and when the second executing module 1002 executes the sending control behavior in the time domain range corresponding to the target parameter, the following is implemented:
executing no sending in the third time domain range, and/or executing sending in the fourth time domain range;
or
when the target parameter is the second preset timer, the second preset timer includes a third timer and/or a fourth timer; and when the second executing module 1002 executes the sending control behavior in the time domain range corresponding to the target parameter, the following is implemented: executing no sending during running of the third timer, and/or executing sending during running of the fourth timer.

In some embodiments, when the target parameter is the second preset time domain range, the second preset time domain range includes a third time domain range and/or a fourth time domain range; and when the second executing module 1002 executes transmission or reception control behavior of the target object in the time domain range corresponding to the target parameter, the following is implemented:
not sending, by the second terminal, the target object in the third time domain range, and/or sending, by the second terminal, the target object in the fourth time domain range;
or
when the target parameter is the second preset timer, the second preset timer includes a third timer and/or a fourth timer; and when the second executing module 1002 executes transmission or reception control behavior of the target object in the time domain range corresponding to the target parameter, the following is implemented: not sending, by the second terminal, the target object during running of the third timer, and/or sending, by the second terminal, the target object during running of the fourth timer.

In some embodiments, when the time domain range includes a third sub-time domain range and/or a fourth sub-time domain range, a length of at least one of the third sub-time domain range or the fourth sub-time domain range is greater than or equal to at least one of the following parameters:
a packet delay budget PDB;
32 slots;

M×P, where P is a reservation period, a service period, a period indicated by sidelink control information SCI, a period of a sidelink configure grant (SL CG), or a period of sidelink semi-persistent scheduling, and M is a positive integer; and

J slots or milliseconds, where J is greater than or equal to 32+N and is less than or equal to 32+N+K−1, or J is greater than or equal to RA_duration+N and is less than or equal to RA_duration+N+K−1, N is a period of a feedback resource, K is a minimum time interval between a transmission or reception resource and a corresponding feedback resource, RA_duration is a time domain range or a time domain distance occupied by two transmission or reception resources in preset transmission or reception resources, and the preset transmission or reception resource is a transmission or reception resource included in SL SPS, a transmission or reception resource included in an SL CG, a transmission or reception resource scheduled by SL DCI, or a transmission or reception resource indicated by SCI, where
when the target parameter is the second preset timer, and the second preset timer includes a third timer and/or a fourth timer, the third sub-time domain range corresponds to timing duration of the third timer, and the fourth sub-time domain range corresponds to timing duration of the fourth timer; and
when the target parameter is the second preset time domain range and the second preset time domain range includes a third time domain range and/or a fourth time domain range, the third sub-time domain range corresponds to the third time domain range, and the fourth sub-time domain range corresponds to the fourth time domain range.

In some embodiments, the terminal further includes:
a fourth obtaining module, configured to obtain a second target moment, where the second target moment is a second preset moment, or the second target moment is a moment when the second preset moment is shifted by a second offset; and
the second target moment is a start point of the time domain range.

Further, when the target parameter is the second preset timer, after the fourth obtaining module obtains the second target moment, the terminal further includes:
a second starting module, configured to start the second preset timer at the second target moment.

In some embodiments, the second preset moment includes at least one of the following:
a moment at which a resource is preempted;
a moment at which the last transmission or reception resource is located;
a moment related to sending the last transmission or reception resource;
a moment at which a feedback resource corresponding to the first transmission or reception resource is located;
a moment at which a feedback resource corresponding to the last transmission or reception resource is located;
a moment at which a feedback resource is received or monitored;
a moment at which a first response is received or monitored;
a moment at which a physical uplink control channel PUCCH or a physical uplink shared channel PUSCH is sent;
a moment related to receiving or monitoring a negative acknowledgment;
a moment related to receiving or monitoring no first response;
a moment related to receiving or monitoring no feedback resource;
a moment at which a transmission or reception resource on which a target object is not sent is located when the target object is not sent on a reserved or indicated resource; or
a moment at which a feedback resource corresponding to the transmission or reception resource on which the target object is not sent is located when the target object is not sent on the reserved or indicated resource.

Further, the moment at which the feedback resource is received or monitored includes: a moment at which the A^{th} feedback resource is received or monitored; or
a moment at which the feedback resource corresponding to the last transmission or reception resource is received or monitored, where
A is a positive integer.

Further, it should be noted that the moment related to the case that the negative acknowledgment is received or monitored includes at least one of the following:
a moment related to receiving or monitoring the first negative acknowledgment;
a moment related to receiving or monitoring each negative acknowledgment; or
a moment related to a case that the last feedback resource is received or monitored and feedback content is a negative acknowledgment.

Further, the moment related to the case that no feedback resource is received or monitored includes at least one of the following:
a moment related to receiving or monitoring no feedback resource for the first time;
a moment related to receiving or monitoring no feedback resource each time; or
a moment related to receiving or monitoring no feedback resource last time if all feedback resources are not received or monitored.

Further, the moment at which the transmission or reception resource on which the target object is not sent is located when the target object is not sent on the reserved or indicated resource includes:
a moment at which the last transmission or reception resource on which the target object is not sent is located when the target object is not sent on the reserved or indicated resource.

Further, the moment at which the feedback resource corresponding to the transmission or reception resource on which the target object is not sent is located when the target object is not sent on the reserved or indicated resource includes:
a moment at which a feedback resource corresponding to the last transmission or reception resource on which the target object is not sent is located when the target object is not sent on the reserved or indicated resource.

In some embodiments, the second preset moment includes at least one of the following:
a moment related to the latest transmission or reception resource in obtained at least one target resource; or
a moment related to a feedback resource corresponding to the latest transmission or reception resource in the obtained at least one target resource, where
the ta rget resource includes at least one of the following:
a transmission or reception resource reserved or indicated by sidelink control information SCI, a transmission or reception resource indicated by sidelink downlink control information SL DCI, a transmission or reception resource included in sidelink semi-persistent scheduling SL SPS, or a transmission or reception resource included in a sidelink configured grant (SL CG).

In some embodiments, the target resource is a target resource in the active time.

In some embodiments, the second preset moment includes at least one of the following:
a moment related to the sent last piece of sidelink control information SCI;
a moment related to the obtained last piece of sidelink downlink control information SL DCI; or
a moment at which the reserved or indicated R^{th} resource is located—n, where
n is a preset value.

Further, a length of the fourth time domain range or the fourth timer covers a time of at least one of the following transmission or reception resources obtained by the second terminal:
a transmission or reception resource indicated or reserved by at least one piece of sidelink control information SCI;
a transmission or reception resource indicated by at least one piece of sidelink downlink control information SL DCI;
a transmission or reception resource included in at least one piece of sidelink semi-persistent scheduling SL SPS; or
a transmission or reception resource included in at least one sidelink configured grant (SL CG).

In some embodiments, the transmission or reception configuration is a sidelink discontinuous reception DRX configuration.

It should be noted that the terminal embodiment is the terminal corresponding to the foregoing transmission or reception configuration method performed by the second terminal. All implementations of the foregoing embodiment are applicable to the terminal embodiment, nd a same technical effect can also be achieved.

It should be further noted that an embodiment of the present disclosure further provides a terminal, where the terminal is a second terminal, and a specific structure of the second terminal is the same as the specific structure of the first terminal shown in FIG. 8.

In some embodiments, the processor of the second terminal is configured to: obtain a transmission or reception configuration, where the transmission or reception configuration is used to configure a target parameter; and execute at least one of the following according to the transmission or reception configuration:
executing a sending control behavior in a time domain range corresponding to the target parameter; or
executing a transmission or reception control behavior of a target object in the time domain range corresponding to the target parameter, where
the target parameter includes a second preset time domain range or a second preset timer.

It should be further noted that the processor of the second terminal is further configured to implement other processes in the transmission or reception configuration method performed by the second terminal in the foregoing embodiment, and details are not described herein again.

An embodiment of the present disclosure further provides a terminal. The terminal is a second terminal and includes a processor, a memory, and a computer program that is stored in the memory and that can be run on the processor. When the computer program is executed by the processor, the foregoing processes of the transmission or reception configuration method embodiment performed by the second terminal side are implemented and a same technical effect can be achieved. To avoid repetition, details are not described herein again.

An embodiment of the present disclosure further provides a computer-readable storage medium. The computer-readable storage medium stores a computer program, and when the computer program is executed by a processor, the foregoing processes of the transmission or reception configuration method embodiment performed by the second terminal are implemented and a same technical effect can be achieved. To avoid repetition, details are not described herein again. The computer-readable storage medium includes a Read-Only Memory (ROM), a Random Access Memory (RAM), a magnetic disk, or an optical disc.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element.

A person of ordinary skill in the art may be aware that, in combination with the examples described in the embodiments disclosed in this specification, units and algorithm steps may be implemented by using electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed operating process of the foregoing system, apparatus, and unit, refer to a corresponding process in the foregoing method embodiments. Details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, or each of the units may exist alone physically, or two or more units are integrated into one unit.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of the present disclosure essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network side device, or the like) to perform the methods described in the embodiments of the present disclosure.

A person of ordinary skill in the art may understand that all or some of the processes of the methods in the embodiments may be implemented by a computer program controlling related hardware. The program may be stored in a computer readable storage medium. When the program runs, the processes of the methods in the embodiments are executed. The foregoing storage medium may be a magnetic disc, an optical disc, a Read-Only Memory (ROM), a Random Access Memory (RAM), or the like.

It can be understood that the embodiments described in the embodiments of the present disclosure may be implemented by hardware, software, firmware, middleware, microcode, or a combination thereof. For hardware implementation, a module, a unit, or a subunit may be implemented in one or more Application Specific Integrated Circuits (ASIC), Digital Signal Processor (DSP), DSP Device (DSPD), Programmable Logic Device (PLD), Field-Programmable Gate Array (FPGA), general purpose processors, controllers, microcontrollers, microprocessors, or other electronic units or a combination thereof used to perform the functions in the present disclosure.

For software implementation, the technology in the embodiments of the present disclosure may be implemented through modules (for example, procedures or functions) that perform the functions in the embodiments of the present disclosure. Software code may be stored in a memory and executed by a processor. The memory may be implemented in the processor or outside the processor.

The foregoing descriptions are merely implementations of the present disclosure. It should be noted that a person of ordinary skill in the art may make several improvements and polishing without departing from the principle of the present disclosure and the improvements and polishing shall fall within the protection scope of the present disclosure.

1. A transmission or reception configuration method, performed by a first terminal, comprising:
obtaining a transmission or reception configuration, wherein the transmission or reception configuration is used for configuration of a target parameter, wherein the target parameter comprises a first preset timer, and the first preset timer comprises a round-trip time timer (RTT timer);
obtaining a first target moment; and
starting the first preset timer at the first target moment,
wherein the first target moment is a first preset moment or the first target moment is a moment when the first preset moment is shifted by a first offset, wherein the first preset moment comprises a moment at which a physical uplink control channel (PUCCH) is sent or a moment associated with a last obtained sidelink downlink control information (SL DCI).

2. The transmission or reception configuration method according to claim 1, further comprising:
executing at least one of the following according to the transmission or reception configuration:
executing a sensing control behavior in a time domain range corresponding to the target parameter;
executing a measurement control behavior in the time domain range corresponding to the target parameter;
executing a resource selection or reselection control behavior in the time domain range corresponding to the target parameter; or
executing a transmission or reception control behavior of a target object in the time domain range corresponding to the target parameter,
wherein the target object comprises at least one of the following:
a first request;
a sidelink control information (SCI);
a physical sidelink control channel (PSCCH);
a physical sidelink shared channel (PSSCH);
a reference signal (RS); or
a measurement report.

3. The transmission or reception configuration method according to claim 2, wherein executing the sensing control behavior in the time domain range corresponding to the target parameter comprises:
executing no sensing during running of the RTT timer.

4. The transmission or reception configuration method according to claim 2, wherein executing the measurement control behavior in the time domain range corresponding to the target parameter comprises:
executing no measurement during running of the RTT timer, and/or executing measurement during running of a second timer.

5. The transmission or reception configuration method according to claim 2, wherein executing the resource selection or reselection control behavior in the time domain range corresponding to the target parameter comprises at least one of the following:
executing no resource selection or reselection during running of the RTT timer; or
not selecting or reselecting, by the first terminal, a resource during running of a first timer.

6. The transmission or reception configuration method according to claim 2, wherein executing the transmission or reception control behavior of the target object in the time domain range corresponding to the target parameter comprises:
not monitoring or not receiving, by the first terminal, the target object during running of the RTT timer.

7. The transmission or reception configuration method according to claim 2, wherein the first target moment is a starting point of the time domain range.

8. The transmission or reception configuration method according to claim 1, wherein the first preset moment further comprises at least one of the following:
a moment at which a resource is preempted;
a moment at which the last transmission or reception resource is located;
a moment related to receiving the last transmission or reception resource;
a moment at which a feedback resource corresponding to the first transmission or reception resource is located;
a moment at which a feedback resource corresponding to the last transmission or reception resource is located;
a moment at which a first response is sent;
a moment at which a physical uplink shared channel (PUSCH) is sent;
a moment related to sending a negative acknowledgment;
a moment related to sending no first response;
a moment at which a transmission or reception resource on which no target object is monitored or received is located when no target object is monitored or received on a reserved or indicated resource; or
a moment at which a feedback resource corresponding to the transmission or reception resource on which no target object is monitored or received is located when no target object is monitored or received on the reserved or indicated resource.

9. The transmission or reception configuration method according to claim 1, wherein the transmission or reception configuration is a sidelink discontinuous reception (DRX) configuration.

10. A transmission or reception configuration method, performed by a second terminal, comprising:
obtaining a transmission or reception configuration, wherein the transmission or reception configuration is used for configuration of a target parameter, wherein the target parameter comprises a second preset timer, and the second preset timer comprises a round-trip time timer (RTT timer);
obtaining a second target moment; and
starting the second preset timer at the second target moment,
wherein the second target moment is a second preset moment or the second preset moment shifted by a second offset, wherein the second preset moment comprises a moment at which a physical uplink control channel (PUCCH) is sent or a moment associated with a last obtained sidelink downlink control information (SL DCI).

11. The transmission or reception configuration method according to claim 10, further comprising:
executing at least one of the following according to the transmission or reception configuration:
executing a sending control behavior in a time domain range corresponding to the target parameter; or
executing a transmission or reception control behavior of a target object in the time domain range corresponding to the target parameter,
wherein the target object comprises at least one of the following:
a first request;
a sidelink control information (SCI);
a physical sidelink control channel (PSCCH);
a physical sidelink shared channel (PSSCH);
a reference signal (RS); or
a measurement report.

12. The transmission or reception configuration method according to claim 11, wherein:
executing the sending control behavior in the time domain range corresponding to the target parameter comprises:
executing no sending during running of the RTT timer; and
executing the transmission or reception control behavior of a target object in the time domain range corresponding to the target parameter comprises:
not sending, by the second terminal, the target object during running of the RTT timer.

13. The transmission or reception configuration method according to claim 10, wherein the transmission or reception configuration is a sidelink discontinuous reception (DRX) configuration.

14. The transmission or reception configuration method according to claim 10, wherein the second preset moment further comprises at least one of the following:
a moment at which a resource is preempted;
a moment at which the last transmission or reception resource is located;
a moment related to sending the last transmission or reception resource;
a moment at which a feedback resource corresponding to the first transmission or reception resource is located;
a moment at which a feedback resource corresponding to the last transmission or reception resource is located;
a moment at which a feedback resource is received or monitored;
a moment at which a first response is received or monitored;
a moment at which a physical uplink control channel PUCCH or a physical uplink shared channel PUSCH is sent;
a moment related to receiving or monitoring a negative acknowledgment;
a moment related to receiving or monitoring no first response;
a moment related to receiving or monitoring no feedback resource;
a moment at which a transmission or reception resource on which a target object is not sent is located when the target object is not sent on a reserved or indicated resource; or
a moment at which a feedback resource corresponding to the transmission or reception resource on which the target object is not sent is located when the target object is not sent on the reserved or indicated resource.

15. A terminal, comprising a memory, a processor, and a computer program that is stored in the memory, wherein the processor is configured to execute the computer program to perform operations comprising:
obtaining a transmission or reception configuration, wherein the transmission or reception configuration is used for configuration of a target parameter, wherein the target parameter comprises a first preset timer, and the first preset timer comprises a round-trip time timer (RTT timer);
obtaining a first target moment; and
starting the first preset timer at the first target moment,
wherein the first target moment is a first preset moment or the first preset moment shifted by a first offset, wherein the first preset moment comprises a moment at which a physical uplink control channel (PUCCH) is sent or a moment associated with a last obtained sidelink downlink control information (SL DCI).

16. The terminal according to claim 15, wherein the operations further comprise:
executing at least one of the following according to the transmission or reception configuration:
executing a sensing control behavior in a time domain range corresponding to the target parameter;
executing a measurement control behavior in the time domain range corresponding to the target parameter;
executing a resource selection or reselection control behavior in the time domain range corresponding to the target parameter; or
executing a transmission or reception control behavior of a target object in the time domain range corresponding to the target parameter,
wherein the target object comprises at least one of the following:
a first request;
a sidelink control information (SCI);
a physical sidelink control channel (PSCCH);
a physical sidelink shared channel (PSSCH);
a reference signal (RS); or
a measurement report.

17. The terminal according to claim 16, wherein executing the sensing control behavior in the time domain range corresponding to the target parameter comprises:
executing no sensing during running of the RTT timer.

18. The terminal according to claim 16, wherein executing the measurement control behavior in the time domain range corresponding to the target parameter comprises:
executing no measurement during running of the RTT timer, and/or executing measurement during running of a second timer.

19. The terminal according to claim 16, wherein executing the resource selection or reselection control behavior in the time domain range corresponding to the target parameter comprises at least one of the following:
executing no resource selection or reselection during running of the RTT timer; or
not selecting or reselecting a resource during running of a first timer.

20. The terminal according to claim 16, wherein executing the transmission or reception control behavior of the target object in the time domain range corresponding to the target parameter comprises:
not monitoring or not receiving the target object during running of the RTT timer.
